(19) United States
(12) Patent Application Publication
(10) Pub. No.: US 2006/0206269 A1
(43) Pub. Date: Sep. 14, 2006

(54) One-dimensional QSAR models

(75) Inventors: David John Diller, East Windsor, NJ (US); Norman Wang, San Diego, CA (US); Robert Kirk DeLisle, Longmont, CO (US); Andrei Victor Anghelescu, Old Bridge, NJ (US)

Correspondence Address: PRIEST & GOLDSTEIN PLLC, 5015 SOUTHPARK DRIVE, SUITE 230, DURHAM, NC, 27713-7736, US

(73) Assignee: Pharmacopeia Drug Discovery, Inc., Cranbury, NJ (US)

(21) Appl. No.: 11/283,650

(22) Filed: Nov. 21, 2005

Related U.S. Application Data
(60) Provisional application No. 60/629,660, filed on Nov. 19, 2004.

(51) Int. Cl. G06F 19/00

(52) U.S. Cl. 702/19; 702/22

(57) ABSTRACT

A set of molecules, the members of which have the same type of biological activity, are represented as one-dimensional strings of atoms. The one-dimensional strings of all members of the set are aligned, in order to obtain a multiple alignment profile of a consensus active compound. The one-dimensional multiple alignment profile is used in deriving a one-dimensional QSAR model to identify other compounds likely to have the same biological activity, and also may be used to derive a three-dimensional multiple alignment profile of the molecules in the set.

This application claims the benefit of U.S. Provisional Application Ser. No. 60/629,660 filed Nov. 19, 2004.

### BACKGROUND OF THE INVENTION

Field of the Invention

The invention relates to methods and systems for making molecular comparisons, and for constructing models to predict biological activity of new molecules.

Description of the Related Art

Drug design is an optimization process, starting with one or more lead compounds that display a desired biological activity. The objective of the optimization is to modify and improve upon the lead compound(s), with the hope of ultimately deriving a drug candidate that demonstrates the required therapeutic efficacy and safety.

Without a detailed understanding of the biochemical process(es) responsible for a lead compound's activity, a typical optimization strategy is to examine structural similarities and differences between active and inactive molecules. The follow-up compounds then selected for synthesis and testing are those that maximize the presence of functional groups or features believed to be responsible for activity.

In order to reduce the time and effort required to identify safe and effective pharmaceuticals, researchers have attempted to characterize the behavior of certain compounds without the need to actually perform synthesis and testing of such compounds. Generally, these efforts have focused on the prediction of molecular behavior by a computational analysis of chemical structure. Although this approach has not eliminated the need to perform chemical experiments, the amount of such testing can be considerably reduced by early identification of promising leads, and by eliminating from consideration compounds which are extremely unlikely to exhibit a particular desired biological activity or are likely to exhibit an undesirable activity.

Quantitative structure-activity relationship (“QSAR”) models represent an attempt to correlate structural or property descriptors of compounds with activities. These physicochemical descriptors, which include parameters to account for hydrophobicity, topology, electronic properties, and steric effects, can be determined by computational methods.

A QSAR model attempts to find consistent relationships between the variations in the values of these physicochemical descriptors and the biological activity for a series of compounds, so that these “rules” can be used to evaluate new chemical entities. A QSAR model often takes the form of a linear equation:
Biological Activity=Constant+(C₁·P₁)+(C₂·P₂)+(C₃·P₃)+. . . (Cₙ·Pₙ)
where the parameters P₁ through Pₙ are the computed physicochemical descriptors for each molecule in the series, and the coefficients C₁ through Cₙ are calculated by fitting variations in the parameters and the biological activity.

Generally, molecules that are in some sense more “similar” to a molecule with known activity are predicted to be more likely to exhibit similar chemical behavior. In bioinformatics, DNA and protein sequence alignment is the foundation for determining structural similarity, and thus the likelihood of similarity in function. In cheminformatics, a host of chemical similarity measures are used to assess the similarity between pairs of small molecules, and thus the likelihood of these having similar function, i.e., biological activity. The list of similarity identification techniques for small molecules includes substructure fingerprints (see, e.g., Martin, Y. C., Kofron, J. L. & Traphagen, L. M. (2002) J Med Chem 45, 4350-8; Durant, J. L., Leland, B. A., Henry, D. R. & Nourse, J. G. (2002) J Chem Inf Comput Sci 42,1273-80); pharmacophore fingerprints (see, e.g., Makara, G. M. (2001) J Med Chem 44, 3563-71; Mason, J. S., Morize, I., Menard, P. R., Cheney, D. L., Hulme, C. & Labaudiniere, R. F. (1999) J Med Chem 42, 3251-64; Mason, J. S., Good, A. C. & Martin, E. J. (2001) Curr Pharm Des 7, 567-97; McGregor, M. J. & Muskal, S. M. (1999) J Chem Inf Comput Sci 39, 569-74; McGregor, M. J. & Muskal, S. M. (2000) J Chem Inf Comput Sci 40, 117-25); and overall 3-D alignments (see, e.g., Rarey, M. & Stahl, M. (2001) J Comput Aided Mol Des 15, 497-520; Lemmen, C., Lengauer, T. & Klebe, G. (1998) J Med Chem 41, 4502-20; Lemmen, C. & Lengauer, T. (2000) J Comput Aided Mol Des 14, 215-32).

For the purpose of finding molecules with similar function, DNA and protein sequence alignment have several advantages over methods for determining chemical similarity. A protein sequence alignment will typically involve on the order of 100-1000 amino acids. A small molecule, on the other hand, has typically only 20-40 atoms. Thus the problem of determining chemical similarity does not have the same statistical power of large numbers. To further complicate matters, the biological activity of a small molecule often hinges on a single atom. Indeed, there are numerous cases in which the change, deletion, or addition of a single atom completely abolishes or changes the biological activity of a small molecule. The diversity of chemical similarity measures reflects the complexity of the biological recognition of small molecules.

Despite the aforementioned differences, the problems of assigning function to a protein and assigning function to a small molecule share a common challenge. Often two proteins with little or no overall sequence identity share a common function. An example is the serine protease family in which only the catalytic triad (Ser, Asp and His) is required for function, while the remainder of the amino acids largely serve to precisely position the catalytic triad. Over a few hundred amino acids, three residues have negligible effect on the overall sequence identity. Similarly, two small molecules with little or no obvious similarity may possess the same biological activity. Much like the example of the serine protease family given above, the binding of a small molecule to a specific protein often relies on only a few key interaction points, such as hydrogen bond acceptors, donors, aromatic rings, etc., with the remainder of the molecule serving to precisely position the key interaction points. The set of interaction points and their precise arrangement is referred to as the pharmacophore.

Bioinformatics addresses the issue of identifying relationships between proteins in large part through multiple sequence alignments. The advantage of multiple sequence alignment versus pairwise alignment is that multiple sequence alignment can find residues that are conserved over an entire protein family, thereby distinguishing the critical amino acids or motifs such as the catalytic triad of the serine protease family. The most comparable technique in computational chemistry is pharmacophore modeling. In this case, multiple small molecules are aligned in three dimensions. The features that the majority of the small molecules share are analogous to the conserved amino acids of a multiple sequence alignment. Much like a multiple sequence alignment can be used to search for related family members, a pharmacophore model can be used to search through a small molecule database for molecules with the same biological activity.

A key difference between multiple sequence alignment and pharmacophore modeling is that multiple sequence alignment is inherently a one-dimensional search problem and therefore is amenable to a host of specialized algorithms. Pharmacophore modeling, however, is inherently a high-dimensional problem involving, for each molecule, three rotational and three translational degrees of freedom, and sometimes many conformational degrees of freedom. In computational chemistry, three-dimensional methods in general, and pharmacophore modeling in particular, suffer from the problem of conformational explosion as the number of rotatable bonds increases. This conformational explosion makes the initial elucidation of the pharmacophore extremely challenging and affects both the quality and speed of the search of the conformational database.

One recently-developed method for calculating molecular similarity of small molecules is directly analogous to pairwise sequence alignment of proteins. See Dixon, S. L. & Merz, K. M., Jr. (2001) J Med Chem 44, 3795-809; see also U.S. Patent Application Pub. No. US2003/0055802A1. The disclosures of these two references (collectively, “Dixon and Merz”) are incorporated by reference herein in their entireties. In this method, the atoms of the small molecule, either from 3-dimensional coordinates or 2-dimensional topological distances, are projected onto one dimension using multi-dimensional scaling. This results in the molecule being represented as a one-dimensional string of atoms, where the atom pairwise distances retain much of the information concerning their true two- or three-dimensional distances. Once two molecules have been projected to one dimension, they can be rapidly aligned using the techniques of pairwise alignment. The chief differences between pairwise DNA and protein sequence alignment vs. pairwise one-dimensional molecular alignment are that, for one-dimensional molecular alignment, (1) both relative orientations of the one-dimensional string must be considered; (2) insertions and deletions do not make sense in the context of a small molecule; and (3) for small molecule alignment, the one-dimensional representations can be translated continuously relative to one another rather than in discrete steps such as for sequences of amino acids or nucleic acids.

While there is some information lost in relying on the one-dimensional representation of molecules when compared to 3D modeling, certain problems also may be avoided. For example, the 3D alignment of many molecules grows exponentially in difficulty in the number of molecules and in the number of potential conformations of the molecules. Because of this, 3D-QSAR is typically limited to small data sets with compounds having a common core. Also, in order to make a prediction about a new molecule with a 3D model, the molecule must be fit to the model. The process of fitting potentially many conformations to the 3D model requires the solution of a difficult global optimization problem. As global optimization problems are in general intractable, this adds a substantial degree of error to the problem and significantly slows the process of making predictions with new compounds.

Traditional 2D-QSAR methods do not encounter the above problems associated with 3D methods. Here, “traditional 2D-QSAR” refers to those statistical techniques and pattern recognition methods that use whole molecule descriptors calculated using only atom type and connectivity information (referred to as 2D descriptors); i.e., these do not rely on any explicit 3D coordinates. The advantage of these methods is that each 2D descriptor has a unique value for each molecule and can typically be calculated relatively rapidly. This allows for rapid predictions for new molecules. Furthermore, since there is no uncertainty in the calculation of the descriptor, the only uncertainty in the model prediction is the uncertainty in the model itself.

The major shortcoming of traditional 2D-QSAR in comparison to 3D methods is that while 2D descriptors can capture important features (such as a hydrogen bond donor) in the molecules, they do not capture the relationship between multiple features such as their degree of separation. For some problems, this shortcoming is not critical, but for understanding structure-activity data sets it is absolutely critical, because compounds bind to proteins through specific interactions.

In view of the foregoing deficiencies of two-dimensional and three-dimensional methods, it would be desirable to create a one-dimensional profile from many molecules having the same biological activity, in order to identify the features common to all or most of the molecules. Such a profile could potentially isolate the key features of the molecules, much like a pharmacophore model isolates chemical features and a multiple sequence alignment isolates conserved amino acids. Secondly, such a profile would avoid the difficulties associated with conformational explosion and thus maintain the speed of the Dixon and Merz pairwise alignment of one-dimensional strings.

It would be especially desirable to be able to derive QSAR models using the one-dimensional representations of molecules, in order to avoid the problems of conformational search and 3D alignment, to be able to rapidly make unambiguous predictions for new molecules and yet retain much of the structural information contained in the molecules.

Further, it would be desirable to generate a high-quality and high-speed, three-dimensional alignment of a multiplicity of compounds.

### SUMMARY OF THE INVENTION

The above-identified shortcomings of the prior art have been remedied by the present invention.

In a first embodiment of the invention, a method and a corresponding system are provided for constructing a one-dimensional QSAR model for small molecule drug candidates. The method comprises selecting a set of K reference molecules known either to possess or not possess a biological activity of interest, wherein at least one of the K reference molecules possesses the biological activity of interest; deriving a set of K one-dimensional molecular representations, wherein each of said representations in the set is derived from a different one of the K molecules in said reference set; aligning all K of the one-dimensional representations in said set along a one-dimensional axis, in order to obtain a multiple alignment profile of the K reference molecules; and deriving a computational model of the biological activity of interest using the multiple alignment profile.

In a second embodiment, the above inventive method may further comprise deriving a one-dimensional representation of a candidate molecule; aligning the one-dimensional representation of the candidate molecule with the multiple alignment profile of the K reference molecules; and determining the likelihood that the candidate molecule will have the biological activity of interest, based on the degree of alignment.

In another embodiment, the first embodiment of the invention, described above, may further comprise assigning a set of physicochemical descriptors to each atom in each of the K reference molecules. The descriptors may consist of size, atom type, partial charge, electro-topological state, surface area, pKa, hydrogen bonding capacity, and the like. Each descriptor, and the coordinates of the respective atoms within the current multiple alignment profile, are correlated with the corresponding molecule's level of biological activity to create an iteration of a one-dimensional QSAR model. Then a new multiple alignment profile is derived for the K reference molecules by realigning these molecules to the current iteration of the one-dimensional QSAR model. This method may be iterated until a final version of the one-dimensional QSAR model is obtained.

In yet a further embodiment of the invention, a method and a corresponding system are provided for creating a three-dimensional multiple alignment of a set of molecules. The method comprises selecting a set of K reference molecules known to possess a biological activity of interest; deriving a set of K one-dimensional molecular representations, wherein each of said representations in the set is derived from a different one of the K molecules in said reference set; aligning all K of the one-dimensional representations in said set along a one-dimensional axis, in order to obtain a one-dimensional multiple alignment profile of the K reference molecules; deriving intra-molecular constraints for a three-dimensional multiple alignment, based on the topology of each of the K reference molecules; deriving inter-molecular constraints for a three-dimensional multiple alignment, based on said one-dimensional multiple alignment profile; deriving a preliminary three-dimensional multiple alignment profile of the K reference compounds based on said intra-molecular and inter-molecular constraints; and performing a gradient-based minimization on said preliminary three-dimensional multiple alignment profile.

### BRIEF DESCRIPTION OF THE DRAWINGS

FIG. 1 is a flow chart of a method for building a 1D-QSAR model.

FIG. 2A is a representation of the four possible relative orientations of three one-dimensional objects.

FIG. 2B is a plot of the two-dimensional search space resulting from the multiple alignment of the one-dimensional representations of three molecules.

FIG. 3 is a flow chart of the multiple alignment process.

FIGS. 4A and 4B depict the “BUTTERCUP” atom pairwise similarity matrix.

FIG. 5 illustrates a training set of inhibitors of the human ether-a-go-go potassium channel (hERG), and the resulting multiple alignment profile.

FIGS. 6A and 6B are plots of the overall performance of the one-dimensional, multiple alignment profile of the hERG inhibitors.

FIG. 7 illustrates a training set of inhibitors of the kinase SRC, and the resulting multiple alignment profile.

FIGS. 8A and 8B are plots of the overall performance of the one-dimensional, multiple alignment profile of the SRC inhibitors.

FIG. 9A is a plot of the quadratic penalty and the robust penalty function for quantitative bioactivity data.

FIG. 9B is a plot of the robust penalty function for qualitative bioactivity data.

FIGS. 10A and 10B depict correction for the variation in bioactivity levels measured in different cell lines.

FIGS. 11A and 11B are plots, respectively, of the raw and corrected bioactivities of various hERG inhibitors, as reported in the literature.

FIG. 12 illustrates the one-dimensional representation and corresponding atom descriptors for the hERG inhibitor, Cisapride.

FIGS. 13A and 13B are plots of the observed bioactivities of various hERG inhibitors vs. the bioactivities predicted by the hERG 1D-QSAR model.

FIG. 14 is a plot of the coefficients of the hERG 1D-QSAR model.

FIG. 15 depicts the individual atom contributions to the bioactivities of four known hERG inhibitors, as predicted by the hERG 1D-QSAR model.

FIG. 16 shows the structures of seven different inhibitors of p38 kinase identified, respectively as compounds p38-1 through p38-7.

FIG. 17 depicts the simultaneous three-dimensional alignments of the seven molecules depicted in FIG. 16, performed using the method of the present invention, wherein the structures of each of compounds p38-2 through p38-7 are shown, for clarity, aligned only with the structure of compound p38-1.

### DETAILED DESCRIPTION OF THE INVENTION

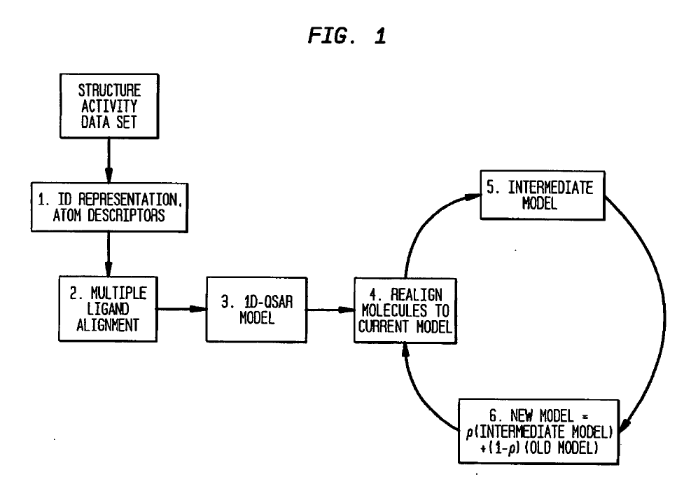

All references cited in this application are incorporated by reference herein in their entireties. A flow chart for the one-dimensional QSAR model building process is shown in FIG. 1, which will now be discussed in detail.

As can be seen in FIG. 1, the starting point for a one-dimensional QSAR model (or any other QSAR model) is a structure-activity data set (“training set”): molecules and associated biological activities such as Ki or IC50 against a particular target. Structure-activity data sets generally have three characteristics that make these challenging to deal with:
1. The data generally has a certain level of variability. Typically, Ki and IC50 data will vary by approximately a factor of 3; i.e., pKi varies by ±0.48.
2. A data set will often have a handful of outliers arising from three sources:
   a. molecules for which the observed biological activity is significantly different from the molecule's true biological activity.
   b. molecules that exhibit the biological activity of interest via a mechanism that is different from that of the majority of the molecules in the data set; for example, molecules that bind in a secondary or allosteric binding site.
   c. molecules for which the representation is not consistent with the nature of the biological interaction; for example, with 3D-QSAR, a molecule that is aligned incorrectly.
3. The structure-activity data set may include molecules with a quantitative potency (such as Ki=30 nM; i.e., pKi=7.52) and/or qualitative potency (such as Ki>10 uM; i.e., pKi<5).
   A reasonable model building procedure should address all three complications.

Prior to building a one-dimensional QSAR model, each molecule in the training set is converted to its one-dimensional representation. See Dixon and Merz. In addition, each atom must be assigned a set of descriptors. (See FIG. 1, in the block numbered “1.”) In principle, any atom descriptor could be used. The list of potential atom descriptors includes size, atom type, partial charge, electro-topological state (“Estate”) (see Hall, L. H., Mohney, B., Kier, L.

B. The electrotopological state: an atom index for QSAR. Quantitative Structure-Activity Relationships 1991, 10, 43-51; Hall, L. H., Mohney, B., Kier, L. B. The electrotopological state: structure information at the atomic level for molecular graphs. Journal of Chemical Information and Computer Sciences 1991, 31, 76-82; Kier, L. B., Hall, L. H. An electrotopological-state index for atoms in molecules. Pharmaceutical Research 1990, 7, 801-807), surface area, pKa, hydrogen bonding capacity, and the like.

At this point, the one-dimensional representations for the individual molecules are essentially unrelated to one another. The second step is to put the molecules into a common frame of reference. (See FIG. 1, in the block numbered “2.”) This results in an initial alignment for the entire training set.

I. One-Dimensional Multiple Alignment

The goal of this section is to describe an approach to derive a consensus one-dimensional alignment of the molecules in the training set. The consensus alignment, referred to as a multiple ligand profile or multiple alignment profile, can be useful directly to search for molecules having similar biological activity or can be used as a starting point in developing a one-dimensional QSAR model.

For the purposes of this description, it is assumed that each of the one-dimensional representations has been created such that its center of mass is 0; i.e., the sum over the one-dimensional coordinates of the atoms of the molecule is 0. If this is not the case, then from each of the one-dimensional coordinates the quantity

$$( 1 / I ) {\sum }_{i = 1 to I} {x}_{i}$$

is subtracted, where l is the number of atoms in this molecule and the xᵢ are the one-dimensional coordinates of the atoms of this molecule. This particular one-dimensional representation is referred to as the “initial one-dimensional representation.” In order to put this molecule's one-dimensional representation into a new frame of reference, its orientation and translation must be specified. The orientation takes the values of 1 or −1, where a value of 1 means to make no change in orientation, while a value of −1 means to flip the one-dimensional representation of the molecule. The translation is a continuous variable; it takes any real value and essentially shifts the one-dimensional representation along the one-dimensional axis. Mathematically, the one-dimensional coordinates are transformed by xᵢ^{new}=ρxᵢ^{initial}+Δx where ρ is the orientation and Δx is the translation.

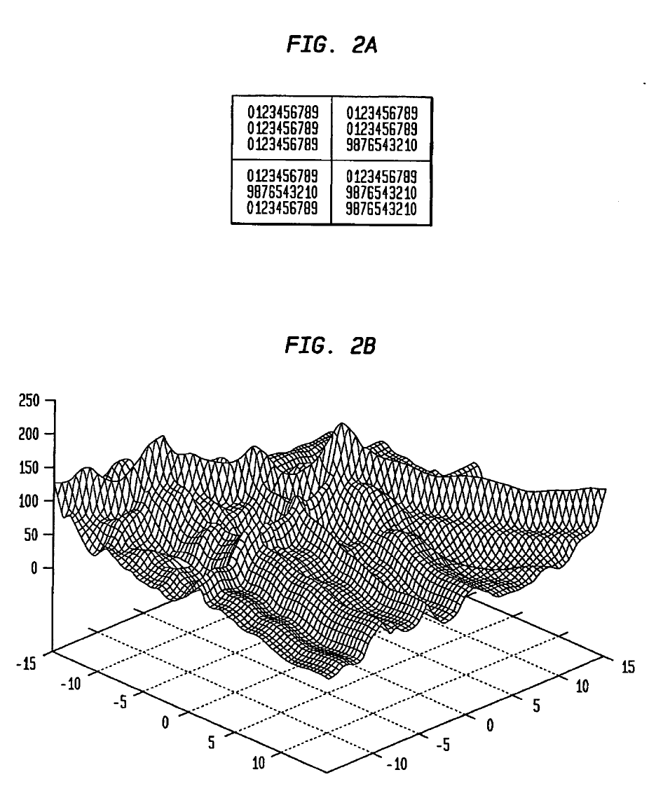

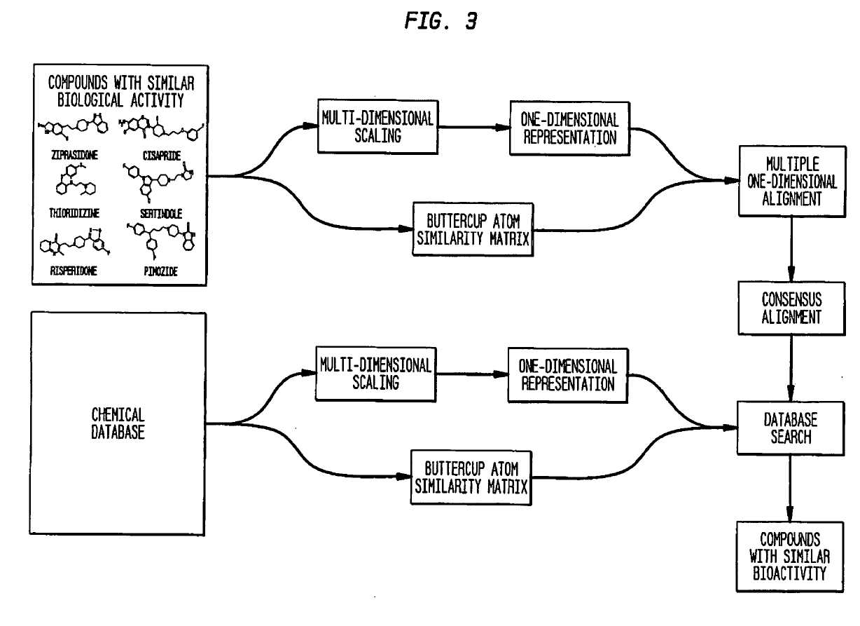

FIG. 2A shows, in a simplified manner, the four possible relative orientations in the alignment of three one-dimensional objects. In order to align K molecules, there are a total of 2^{K-1} possible relative orientations. Thus, with 10 molecules there are 512 possible relative orientations, and with 20 molecules there are over 50,000 possible relative orientations. To find the global maximal alignment, one must solve a continuous global optimization problem in K-1 dimensions for each of the possible 2^{K-1} relative orientations.

Each of these high-dimensional optimization problems involves a very complex similarity landscape with numerous local maxima. A simplified example appears in FIG. 2B, which provides a graphic representation of a two-dimensional search space resulting from the multiple alignment of the one-dimensional representations of only three small molecules: Cisapride, Thioridizine and Ziprasidone. In such an optimization, the number of local maxima likely increases exponentially with the number of molecules. The complexity of the high-dimensional similarity landscape and the large number of discrete relative orientations makes a brute force solution to the overall global optimization problem nearly intractable. In addition, the large number of local maxima and the presence of discrete variables precludes the exclusive use of gradient-based methods.

In order to produce a consensus one-dimensional alignment of multiple molecules, a heuristic approach was used: Evolutionary programming (see, e.g., Fogel, L. J., Owens, A. J. & Walsh, M., J. (1966) Artificial intelligence through simulated evolution (John Wiley and Sons, New York)) is used to address the continuous variables, and genetic algorithms (see, e.g., Holland, J. H. (1975) Adaptation in natural and artificial systems (University of Michigan Press, Ann Arbor)) are used to handle the discrete variables. The combination of genetic algorithms and evolutionary programming has been shown through numerous examples to robustly handle optimization problems with continuous and discrete variables, and thus is particularly well suited to the problem of multiple one-dimensional ligand alignment.

Thus, as described below, a heuristic combination of evolutionary programming and genetic algorithms was used for building a near optimal multiple ligand alignment profile. These profiles were then shown to be useful for rapidly searching large compound databases for novel molecules with the same biological activity.

A flow chart for the multiple alignment process is depicted in FIG. 3. The process begins with the selection of a set of small molecules all having the same type of biological activity. The molecules are converted to their respective one-dimensional representations using the multi-dimensional scaling procedure. The one-dimensional representations then are aligned using the BUTTERCUP scoring matrix and the alignment program, both of which are described below. The output of the alignment program is a multiple alignment profile. The profile can then be used to search small molecule databases for molecules with the same biological activity.

In the alignment program, a heuristic approach utilizing evolutionary programming and genetic algorithms was used to ‘evolve’ a solution, resulting in a multiple alignment profile of the selected set of compounds. According to the scheme depicted in FIG. 3, each small molecule to be aligned is first converted, using only 2-dimensional topological distances, to its one-dimensional representation through the multidimensional scaling and BFGS optimization procedure as described by Dixon and Merz for the pairwise case. Each small molecule's one-dimensional encoding consists of information about the type of each atom (excluding hydrogen atoms) and its one-dimensional coordinate.

Organism/Gene Encoding

The first step in a genetic algorithm or evolutionary program is the generation of an initial population of potential solutions referred to as “organisms.” A population of organisms is created from the set of K one-dimensional molecules. Each organism consists of a set of K genes, with each gene representing the translation and the orientation of the one-dimensional representation of a molecule. The initial set of generated genes contains translations distributed via a Gaussian distribution with mean 0 and standard deviation equal to one-quarter of the molecule's one-dimensional width. Distributing the initial population in a Gaussian fashion ensures that most of the molecules have some area of overlap with the other molecules. The initial orientation of each gene was chosen purely randomly. For the examples contained herein, a population size of 128 was used, and 500 iterations of the evolutionary process described below were performed to arrive at near optimal multiple alignment profiles.

Alignment Scoring/Organism Fitness

In order to assess the fitness of an organism, the quality of any given multiple alignment must be scored. The score is given by

$$Alignment Score = {\sum }_{i < j} {\sum }_{k = 1}^{{N}_{i}} {\sum }_{m = 1}^{{N}_{j}} S ( {a}_{ik} , {a}_{jm} ) f ( {x}_{ik} - {x}_{jm} ) \qquad ( 1 )$$

where the outer sum is over all pairs of molecules in the alignment, the second sum is over the atoms of the ith molecule, the inner sum is over the atoms of the jth molecule, S(aᵢₖ,aⱼₘ) is the similarity of the kth atom of the ith molecule to the mth atom of the jth molecule, xᵢₖ and xⱼₘ are the respective one-dimensional coordinates of the two atoms, and f is a distance-dependent measure of the overlap of the two atoms. The full description of the scoring scheme then requires two components: the atom pairwise similarity matrix, S, and the distance-dependent overlap function, f.
The Overlap Function

The overlap function, f, in equation (1) could reasonably be any number of-functions. For this work the original overlap function proposed by Dixon and Merz was used:

$$f ( dx ) = \{ \begin{matrix}1 - \vert dx \vert & if dx \leq 1 \\ 0 & if \vert dx \vert > 1\end{matrix} \qquad ( 2 )$$

where dx is the difference in the one-dimensional coordinates of the two atoms whose overlap is being measured. This overlap score is best thought of as each atom having a width of 1 bond unit and the overlap being the area under the intersection of the two atoms.
Atom Pairwise Scoring Matrices

Aligning atoms in their one-dimensional molecular representation poses several problems not present when aligning strings of DNA bases or protein amino acids. First, there are no well-established atom similarity matrices such as, for example, the Dayhoff, PAM, MDM, BLOSUM, GCB, and PET similarity matrices for amino acids. Second, there are a large number of factors that could be taken into account in determining atom similarity. These factors include, for example, actual atom type, atom hybridization, partial charge, polarizability, aromaticity, hydrophobicity, pKa, etc. Since many of these factors depend on both the particular atom and its neighbors in the molecule, there could be in essence an infinite number of atom types.

Several scoring matrices were tested for their effect on the alignment of the one-dimensional molecules. Ultimately, the types used were the same as those used by Dixon and Merz. In this scheme, an atom's type is determined by its atomic number, its hybridization, number of bonded hydrogens, and whether it is a member of a ring.

Atom Pairwise Similarity Matrices

The most obvious atom pairwise similarity matrix is the identity matrix: atoms have a similarity of 1 if they have identical type; otherwise, they have a similarity of 0. This matrix proved to be too strict. For example, an acyclic tertiary amine will often be a suitable replacement for a cyclic tertiary amine. With the identity matrix, however, these two types of nitrogens are classified as completely different. The analogy for protein sequence alignment would be to classify amino acids such as leucine and isoleucine as completely different.

Experience has clearly shown that similarity matrices such as the BLOSUM, PAM, and hydrophobicity matrices are significantly more sensitive than the identity matrix. With this in mind the BUBBLES matrix (denoted by M in all equations) was developed with the following rules:
1) Except for the halogens, atoms of different atomic number have no similarity.
2) The similarity between atoms of the same atomic number decreases from 1 to a minimum of 0 via the rules
   a) decrease by 0.4 for each change in hybridization
   b) decrease by 0.2 if one of the atoms is in a ring while the other is not
   c) decrease by 0.2 for each difference in number of hydrogens.
3) The similarity for halogens is 1-0.2*n where n is the difference in the rows of the periodic table of the two halogens.

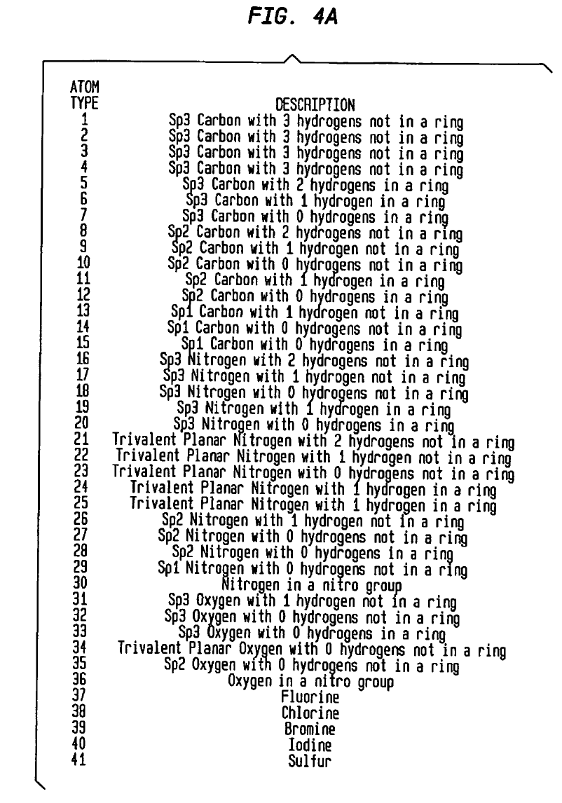

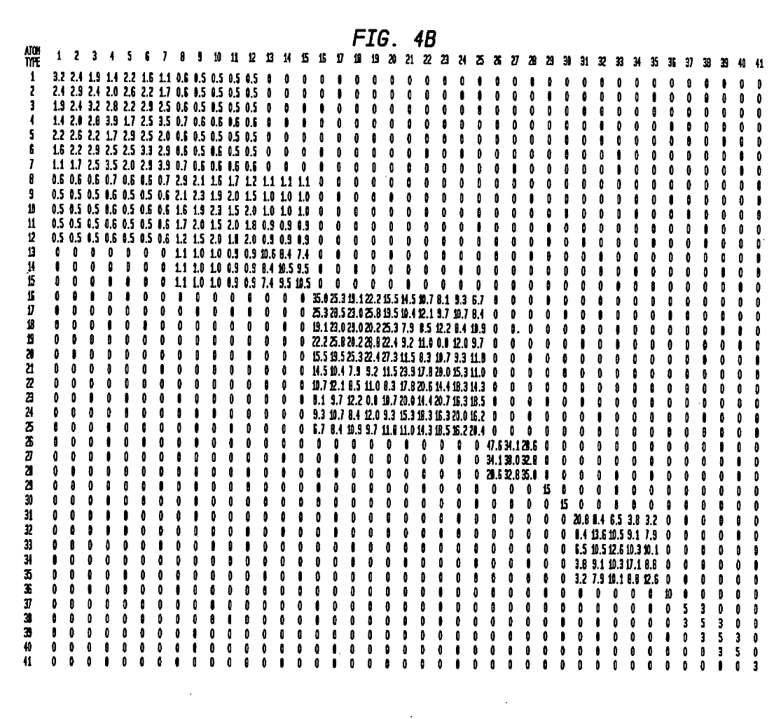

Ultimately, the BUBBLES matrix was not sufficiently discriminating because the alignments were always dominated by the carbon atoms of the molecules. Typically, the carbon atoms act more as the framework of the molecule and less as prominent interactions. To overcome this issue, the MDDR database (MDL, San Leandro, Calif.) was profiled for the frequency of occurrence of each possible atom type. From the vector of occurrences, P, the weighted occurrence vector, W, is defined as
W=MP (3)
where M is the BUBBLES matrix. The element Wⱼ, of the weighted occurrence vector, W, is the expected similarity between an atom of type j and a randomly chosen atom from the MDDR database. The BUTTERCUP matrix, shown in FIGS. 4A and 4B, is then derived from the BUBBLES matrix by scaling with the weighted occurrences. The BUTTERCUP matrix, S, is defined by

$${S}_{ij} = \frac{{M}_{ij}}{\sqrt{{W}_{i} {W}_{j}}} \qquad ( 4 )$$

Ultimately, the BUTTERCUP matrix was used for all atom pairwise similarity calculations.
Selection Process

There are many ways in which a new generation of potential solutions can be created from the previous generation. The selection process here was done through roulette wheel selection (see, e.g., Baeck, T., Fogel, D. B., Michalewicz, Z., Back, T. & Fogel, D. R. R. (2000) Evolutionary Computation 1: Basic Algorithms and Operators (Institute of Physics, Bristol, UK); Baeck, T., Fogel, D. B. & Michalewicz, Z. (2000) Evolutionary Computation 2: Advanced Algorithms and Operators (Institute of Physics, Bristol, UK)) with 100% population replacement from one generation to the next. Given a population of organisms, the probability Qᵢ for organism i to pass on its genes (to have offspring in the next generation) is dependent on its fitness score, E, and the temperature constant, T, via the relationship
Qᵢ∝e^{(E}ᵢ/T) (5)
where the constant of proportionality is chosen so that the sum of the Qᵢ over the population is 1. At high temperatures, the fitness does not exert significant selection pressure on the makeup of the population, and thus a more global search is performed. As the temperature is decreased, the fitness begins to exert more significant selection pressure on the population, and the search becomes more local in nature. Thus, by fluctuating the temperature, the effects of simulated annealing and re-annealing can be achieved. See Kirkpatrick, S., Gelatt, C. D. J. & Vecchi, M. P. (1983) Science 220, 671-680. The temperature was kept at a constant value of 5000 for the purposes of the example herein.
Recombination Process

A genetic algorithm was used to perform crossover with two parents to yield a single offspring. Each gene of the offspring was inherited at random, with a 50% chance of coming from either parent. Thus, at this point, the genome of the offspring would be a random combination of the genomes of its parents. As an alternative, asymmetric crossover could be used.

Mutation Process

After the entire offspring generation is created, two types of random mutations were used: flip mutation and shift mutation. The flip mutation takes the form of bit flipping, which is typical of a genetic algorithm but usually not seen in evolutionary programming. The flip mutation negates the orientation of the one-dimensional representation of the molecule, resulting in a one-dimensional representation that is flipped. The shift mutation uses a Gaussian distribution to change the translation of the one-dimensional representation of the molecules, which is typical of evolutionary programming but usually not seen in genetic algorithms. For any given gene, the probability of a flip mutation was 5%, and the probability of a shift mutation was 5%. The default shift mutation intensity, i.e., the standard deviation in the Gaussian distribution, is 0.5 bond units, resulting in 95% of all changes in translations being between −1 and 1 bond units. Again, one could make these numbers dependent on the temperature factor (see equation (5), above), increasing the mutation rates and intensities as the temperature increased. This would add to the annealing effects described above.

The Compound Database Search

As further depicted in FIG. 3, after the generation of a multiple alignment profile of small molecules having the same biological activity, the profile is used to search small molecule databases with the intent of finding additional small molecules with the same biological activity. In order to assess the likelihood of a small molecule having the desired biological activity, its one-dimensional representation must be aligned to the multiple ligand profile. To find the optimal alignment, two one-dimensional optimizations (both relative orientations) must be performed. Because a profile now involves approximately 300-600 atoms (10-20 molecules of approximately 30 atoms each), strategies different from those used for the single molecule query are necessary in order to maintain the same speed. With two straightforward techniques, the database search can be extremely fast: ˜900 molecules per second on a single SGI R10000 processor (Silicon Graphics. Inc., Mountain View, Calif. 94043).

The first technique is to create a lookup table for each atom type at the beginning of the database search. To do so, a fixed step size (usually 0.1 bond units) and upper and lower limits (the limits of the multiple alignment profile) are chosen. Beginning at the lower limit, the score for atom type 1 is calculated and stored in the first position of an array. Next, the atom is moved one step size to the right, and the score for the atom is calculated and stored in the second position of the array. The process is continued until the atom reaches the upper limit. The process is then repeated for each atom type. When the score for a molecule needs to be calculated, the score for each atom can be found from the appropriate array. The memory needed to store the arrays is less than 1 Mb.

The second technique is a standard bracketing technique used for solving one-dimensional optimization problems. See, for example, Press, W. H., Flannery, B. P., Teukolsky, S. A. & Vetterling, W. T. (1993) Numercal recipes in C: The art of scientific computing (Cambridge University Press, New York). Again, a fixed step size (usually 0.5 bond units) and upper and lower limits (determined by the bounds of the multiple alignment profile and the bounds of the molecule) are chosen. Beginning at the lower limit, the score for the molecule is calculated. The molecule is moved one step to the right and the score is calculated again. The process is continued until the molecule moves past the upper limit. Three consecutive offsets of the molecule (x1<x2<x3) are said to bracket a maximum if S(x1)<S(x2) and S(x3)<S(x2), where S(x) is the model prediction when the one-dimensional coordinates have been translated by x. Because the scoring function S is continuous, one can mathematically guarantee that under these conditions S will have a local maximum somewhere between x1 and x3. Then standard line optimization techniques can be used to find the local maximum to any desired level of accuracy.

When new molecules are aligned to a multiple alignment profile, the resulting maximal score is somewhat correlated with the size of the molecule. The correlation between maximal score and molecule size appears to be somewhat sub-linear. To remove this effect, the score assigned to a molecule in the database is the maximal score divided by the square root of the number of atoms of the molecule. This, empirically, seems to remove any correlation between score and molecule size.

### WORKING EXAMPLES

### One-Dimensional Multiple Alignment

A relatively large set of small molecules having the same biological activity was collected and split into a training set and a test set. (For this example, the training sets consisted of 10 molecules, and the test sets consisted of at least 50 small molecules known to have the same biological activity.) The small molecules of the training set are used to build the one-dimensional profiles. A random database of molecules is then seeded with the molecules of the test set. The profiles are then used to rank all the molecules in the seeded database. The quality of the search method is judged by the extent to which it differentiates the molecules of the test set from those of the random database.

The random molecules (˜100,000) were drawn from the MDDR database, with a molecular weight cutoff of 600 Da. While it is quite possible that some of these molecules would have one of the biological activities used as a validation, the vast majority would not. Furthermore, the MDDR database consists of drug-like molecules and is representative of the types of small molecules synthesized in medicinal chemistry programs. Thus, selecting random small molecules from the MDDR database makes the tests realistic.

The test cases chosen were: the human ether-a-go-go potassium channel (hERG) and the kinase SRC. Inhibition of the hERG potassium channel has recently been linked to cardiotoxicity such as prolonged QT interval and torsades de pointes. Drugs such as cisapride and terfenadine have been withdrawn from the market because of their propensity to cause fatal arrhythmias. These arrhythmias are believed to be caused by the interaction of these drugs with the hERG potassium channel. Thus, the hERG channel is a counter screen for many medicinal chemistry programs. The kinase SRC has been implicated in a variety of cancers. In addition, SRC is used as a selectivity assay in many kinase programs. Thus, an SRC virtual screen would be useful as a means to generate new leads and as a virtual filter to identify potential selectivity issues in kinase programs.

The hERG Validation Study

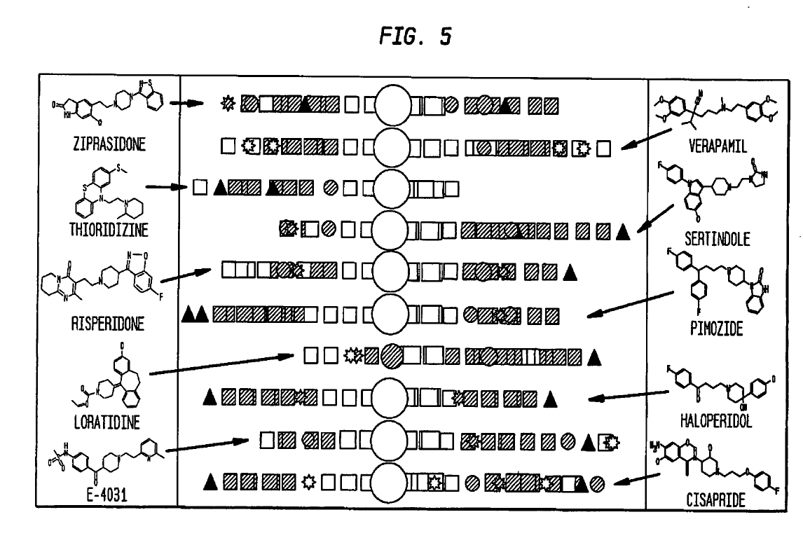

The ten molecules of the training set used to build the hERG one-dimensional profile, and the resulting profile, are shown in FIG. 5. The atoms are shaped by their type and are colored by their hybridization as follows: Carbon—square, Nitrogen—circle, Oxygen—star, Sulfur—diamond, halogens—triangle, Sp3 atoms—white, Sp2 atoms—gray. Note also that sulfur and halogen atoms were all colored black. The size of the atom is proportional to the amount the atom contributes to the score of the overall alignment. The central feature of the hERG profile shown in FIG. 5 is a basic amine—only Loratadine lacks this feature. The basic center is immediately surrounded by aliphatic carbons. Both ends of the profile are dominated by regions of aromatic carbons. In this case, the hERG test set consists of 62 known hERG inhibitors.

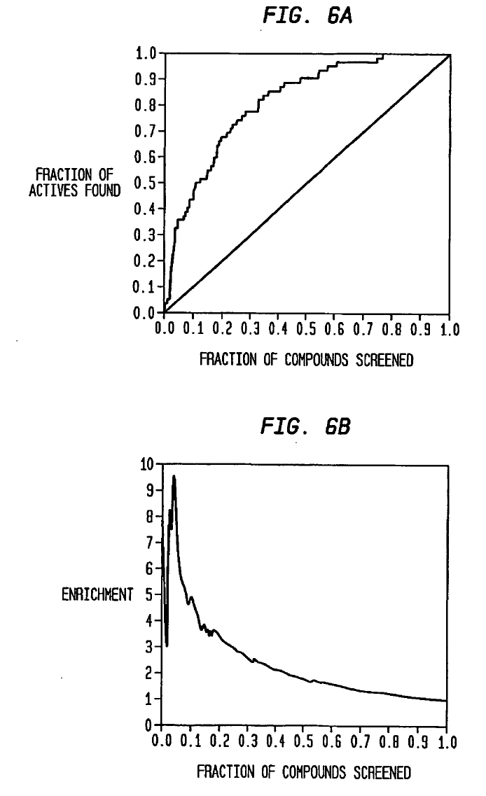

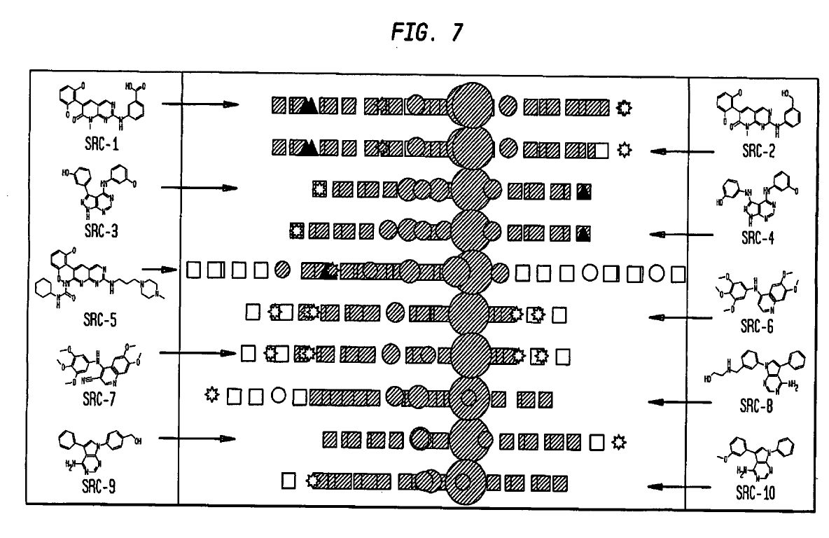

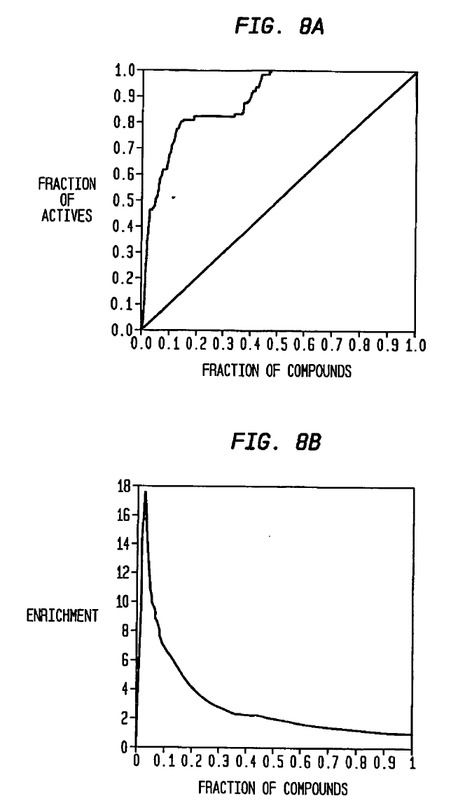

The overall performance of the hERG one-dimensional profile is shown in FIGS. 6A and 6B. In FIG. 6A, the top curve is the fraction of the known hERG actives found versus the fraction of the overall compounds. The diagonal line is the expected performance of a method that selected compounds at random. FIG. 6B is a graph of the enrichment versus the fraction of compounds. (The enrichment is the ratio of the fraction of hERG actives found versus the fraction of the overall compounds.) To summarize FIGS. 6A and 6B, the profile finds 50% of the known hERG actives in the top 10% of the compounds, 70% of the hERG actives in the top 20% of the compounds, and 85% of the hERG actives in the top 40%. The time needed to search the 100,000 random compounds with the multiple ligand profile was 150 seconds on an SGI R10000 processor (Silicon Graphics, Inc., Mountain View, Calif. 94043).

The SRC Validation Study

The SRC one-dimensional profile and the 10 compounds of the training set used to build the profile are shown in FIG. 7—colors and shapes as described for FIG. 5. In this case, the test set consists of 142 known SRC inhibitors. This case is a challenging test case because SRC has been used both as a primary target and as a selectivity target in many kinase medicinal chemistry programs. As a result, the test set contains many different compounds of widely varying chemotypes.

The strongest feature in the SRC one-dimensional profile is a central aromatic nitrogen (see FIG. 7). One could hypothesize that these aligned nitrogens make the hydrogen bond with the backbone NH of the hinge region often observed as critical in kinase-ligand interactions. See, for example, Toledo, L. M., Lydon, N. B. & Elbaum, D. (1999) Curr Med Chem 6, 775-805. In 9 of the 10 molecules used to make the SRC profile, the structure-activity relationships strongly support the aromatic ring aligned to the left of the profile as being the ring that binds in the main hydrophobic pocket. The group that likely binds in the main hydrophobic pocket for molecule SRC-8 (see FIG. 7) is the aromatic ring on the same side as the NH2. Thus, this molecule likely should be oriented the same as SRC-9 and SRC-10. The pseudo-two fold symmetry makes the problem of orienting these three molecules particularly difficult.

The overall results of the database search with the SRC one-dimensional profile are shown in FIG. 8. The results are biphasic. Approximately 80% of the known SRC inhibitors are found in the first 20% of the compounds. No additional SRC inhibitors are found until after the 40 percentile mark. The remainder of the known inhibitors are then found by the 50 percentile mark.

The foregoing examples demonstrate that the one-dimensional representation of small molecules retains much of the information in a small molecule structure. Much like a three-dimensional pharmacophore model, the multiple ligand alignment can effectively isolate the common features of a set of molecules with the same biological activity. This, in turn, makes the alignment profiles useful for searching databases of available small molecules for novel molecules with the same biological activity. In addition, the speed of the searches (˜900 molecules/second) makes these alignment profiles practical for searching large virtual collections. In addition, the speed of the searches allows the profiles to be used multiple times during the cyclic design of combinatorial libraries.

Beyond their ability to locate molecules with the same biological activity, a desirable aspect of models such as the multiple alignment profile is interpretability. The advantage of interpretable models is that these provide a means for molecular modelers and medicinal chemists to rationally improve or eliminate a given biological activity. The interpretability of the one-dimensional multiple alignments is best demonstrated by a comparison with comparable three-dimensional models. Recently, two such three-dimensional models rationalizing the hERG activity of a set of compounds have been published. Ekins and co-workers published a Catalyst pharmacophore model (see Ekins, S., Crumb, W. J., Sarazan, R. D., Wikel, J. H. & Wrighton, S. A. (2002) J Pharmacol Exp Ther 301, 427-34), and Cavali and co-workers published a pharmacophore model combined with a comparative molecular field analysis (“CoMFA”) model (see Cavalli, A., Poluzzi, E., De Ponti, F. & Recanatini, M. (2002) J Med Chem 45, 3844-53). Both models are centered around a positive ionizable feature which is surrounded by large hydrophobic regions. This corresponds nearly perfectly with the above hERG multiple alignment profile, which features a basic amine surrounded by an aliphatic region and an aromatic region on each side.

II. Use of the Multiple Alignment Profile to Derive a 1D-QSAR Model

As indicated in FIG. 1, in the block numbered “3,” from the initial multiple alignment, the first one-dimensional QSAR model is built (see below for the model building details). Generally speaking, this model is built by correlating the atom descriptors and their positions within the alignment to the given potencies. Any statistical or pattern recognition method (see, e.g., Theodoridis, S.; Koutroumbas, K. Pattern Recognition; Academic Press: San Diego, Calif., 1999; Hastie, T., Tibshirani, R.; Friedman, J. The Elements of Statistical Learning. Data Mining, Inference, and Prediction; Springer-Verlag: N.Y., 2001) could be used to build the models. A preferred such method is robust linear regression.

In principle, one could stop with the initial model. In practice, however, the initial alignment is usually not optimal. To improve the alignment, each molecule is realigned to the current one-dimensional QSAR model by choosing the translation and orientation of its one-dimensional representation that maximizes the molecule's predicted potency. (See FIG. 1, in the block numbered “4.”) Because the realigning is a one-dimensional global optimization problem, the search is both reliable and fast (see below for details). By realigning each molecule, a new multiple ligand alignment is derived. With this new multiple ligand alignment, a new iteration of the one-dimensional QSAR model, referred to as the intermediate model, is built. (See FIG. 1, in the block numbered “5.”) Ideally, then, this procedure would be iterated until the model converged. In practice, it has been found that the model converges faster if the model of the next iteration is a weighted average of the model from the previous iteration and the intermediate model. (See FIG. 1, in the block numbered “6.”)

Building a One-Dimensional QSAR Model

The model building process now will be reviewed in greater detail. The following notation conventions are used below: As a general rule, lower case letters represent indices, and the corresponding uppercase letter indicates the limit of an index; for example n=1, . . . , N.

The training set consists of K molecules labeled with a superscript k. Each atom is assigned J descriptors labeled with the subscript j. Thus, dᵢⱼ^{k} indicates descriptor j of atom i of molecule k. I^{k} denotes the number of atoms in molecule k. The potency of molecule k is denoted by a^{k}. Typically, potency is measured by either pKi or plC50.

A bounded interval is defined, and partitioned into N evenly spaced grid cells. The bounds and partitioning of the one-dimensional interval is independent of any particular one-dimensional molecular representation. Typically, the bounds of the interval are chosen to completely encapsulate the multiple alignment profile with sufficient extra space, usually about 5 bond units, on either side. The partitioning is then created by choosing a fixed number of cells and dividing the interval evenly into the chosen number of cells. The resulting cells are numbered from 1 to N using subscript n. As an example, the typical interval used is (−15, 15), and the typical cell size is 0.5; i.e., N=60. Thus, cell 1 has the linear coordinates (−15, −14.5), cell 2=(−14.5, −14), . . . cell n=(−15+0.5(n−1),−15+0.5 n), . . . , cell 60=(14.5, 15).

With a fixed one-dimensional representation, molecule k is assigned the descriptors Dₙⱼ^{k} where n=1, . . . , N, j=1, . . . , J and

$${D}_{nj}^{k} = {\sum }_{i}^{{l}^{k}} {d}_{ ij}^{ k} {f}_{n} ( {x}_{i}^{k} ) for n = 1 , … , N and j = 1 , … , J \qquad ( 6 )$$

where xᵢ^{k} is the one-dimensional coordinate of atom i of molecule k, and fₙ(x) is the fraction of the interval (x−0.5,x+0.5) contained in grid cell n. For n=1, . . . , N, j=1, . . . , J, the Dₙⱼ^{k} are the “whole molecule descriptors” for molecule k. Intuitively, the whole molecule descriptor is a way to connect the atom descriptors to their location along the one-dimensional axis. Ultimately, the whole molecule descriptors are the descriptors used to build the one-dimensional QSAR model. The whole molecule descriptors that correspond to a single atom descriptor are referred to collectively as a “descriptor grid.”

To ease the notational burden, the following discussion alternates between two equivalent notations:
Dₘ^{k}=Dₙⱼ^{k} where m=n+(j−1)N for m=1, . . . , NJ and Dₘ^{k}=1 for m=0. (7)
Dₘ^{k and D}ₙⱼ^{k} are used interchangeably, according to which notation is most convenient.

A linear one-dimensional QSAR model is defined by the choice of the free parameters wₘ for m=0, . . . NJ. Once the coefficients are chosen, any molecule in its one-dimensional representation, along with a chosen orientation and translation, can be assigned a predicted activity via the formula

$$Predicted Activity = {\sum }_{m = 0}^{NJ} {w}_{m} {D}_{m}^{k} . \qquad ( 8 )$$

The coefficients wₘ can be chosen via minimizing the difference between the predicted activity and the observed activity; i.e., by minimizing

$$R ( {w}_{0} , … , {w}_{NJ} ) = {\sum }_{k = 1}^{K} {( {α}_{k} - {\sum }_{m = 0}^{NJ} {w}_{m} {D}_{m}^{k} )}^{2} \qquad ( 9 )$$

which amounts to classical linear least squares. Equation (9) can be solved by any variety of methods. See, for example, Press, W. H.; Teulkolsky, S. A., Vetterling, W. T., Flannery, B. P. Numerical Recipes in C; 2 ed., Cambridge University Press: Cambridge, 1997.

Because the number of descriptors per molecule is comparable to or even larger than the number of data points, simply solving equation (9) may result in over-fitting the data, resulting in a model that does not generalize. Moreover, in cases in which the data set contains outliers, solving equation (9) will result in models that are unduly influenced by those outliers.

To reduce the effective number of descriptors, it is desirable to penalize for excessive variation in the coefficients along any of the descriptor grids via penalizing the magnitude squared of either the first (numerical) derivative

$$First Derivative = \frac{{w}_{( n + 1 ) j} - {w}_{nj}}{dx} \\ n = 1 , 2 , … , N - 1 and j = 1 , … , J \qquad ( 10 )$$

or the second (numerical) derivative

$$Second Derivative = \frac{{w}_{( n + 1 ) j} - 2 {w}_{nj} + {w}_{( n - 1 ) j}}{{dx}^{2}} \\ n = 2 , 3 , … , N - 1 and j = 1 , … , J . \qquad ( 11 )$$

In order to reduce the bias caused by outliers in the training set, we replace the quadratic term in equation (9) with an alternate penalty term, F(z) where z is the difference between observed and predicted activity. The ideal properties for the function F to possess are:
1. F(0)=0
2. F(z)˜0 when z˜0.
3. F is convex.
4. F should be continuously differentiable.
5. F(z) should increase roughly linearly as z gets large; i.e., F′(z)˜1 as z>>1 and F′(z)˜−1 as z<<−1.
   Property 1 says that if the model prediction is identical to the observed value, then no penalty should be incurred. Property 2 allows for a small difference between the predicted and observed potency without significant penalty. This property is desirable, because experimental measurements tend to have a certain level of variation. Thus, a prediction within this level of variation is nearly ideal and should not be significantly penalized. Property 3 guarantees that the resulting function to be minimized has a unique minimum (see equations 13 and 14 below). Property 4 allows this unique minimum to be found via gradient-based techniques such as conjugate gradient minimization. Finally, property 5 minimizes the extent to which the model is affected by the outliers in the training set. Properties 4 and 5 are not strictly necessary, but are often beneficial for the data sets encountered in drug discovery.

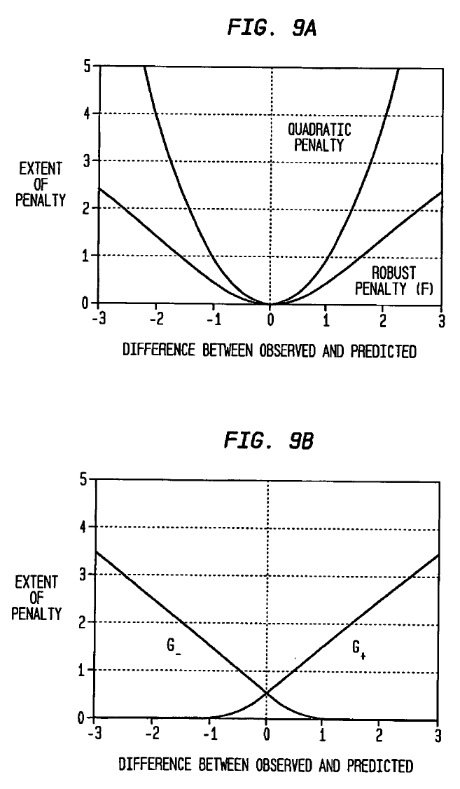

One particular function (the “robust penalty function”) that satisfies the above five properties is

$$F ( z ) = \frac{1}{α} ln ( \frac{1 + {ⅇ}^{α ( z - ɛ )} + {ⅇ}^{- α ( z + ɛ )}}{1 + 2 {ⅇ}^{- αɛ}} ) \qquad ( 12 )$$

where α and ε are positive constants. One can readily verify that F satisfies the five properties listed above. For example, FIG. 9A is a plot of the quadratic penalty and the above robust penalty function from equation (12), where α=4 and ε=0.5. Both curves are convex, and reach their minima when the difference between the predicted and observed potency is zero.

A combination of the robust penalty function and the above penalties for excessive variation in the coefficients results in one of the following two functions:

$$\begin{matrix}{Q}_{1} ( {w}_{0} , … , {w}_{NJ} ) = {\sum }_{k = 1}^{K} F ( {a}_{k} - {\sum }_{m = 0}^{NJ} {w}_{m} {D}_{m}^{k} ) + {γ}_{1} {\sum }_{j = 1}^{J} ( {w}_{1 j}^{2} + {w}_{Nj}^{2} ) + {γ}_{2} {\sum }_{j = 1}^{J} {\sum }_{n = 1}^{N - 1} {( \frac{{w}_{( n + 1 ) j} - {w}_{nj}}{dx} )}^{2} \\ or & ( 13 ) \\ {Q}_{2} ( {w}_{0} , … , {w}_{NJ} ) = {\sum }_{k = 1}^{K} F ( {a}_{k} - {\sum }_{m = 0}^{NJ} {w}_{m} {D}_{m}^{k} ) + {γ}_{1} {\sum }_{j = 1}^{J} ( {w}_{1 j}^{2} + {w}_{Nj}^{2} ) + {γ}_{2} {\sum }_{j = 1}^{J} {\sum }_{n = 2}^{N - 1} {( \frac{{w}_{( n + 1 ) j} - 2 {w}_{nj} + {w}_{( n - 1 ) j}}{{dx}^{2}} )}^{2} & ( 14 )\end{matrix}$$

where γ₁ and γ2 are positive constants. The first term measures the extent to which the model agrees with the observed activities. The second term (weighted by γ₁) attempts to force the coefficients at the ends of each descriptor grid to be 0. The third term (weighted by γ₂) penalizes the model for excessive variation in the coefficients along a descriptor grid. The model coefficients, W₀, W₁. . . W_{NJ}, are then determined by minimizing either (13) or (14).

The last potential complication is the presence of qualitative data such as Ki>10 uM (pKi<5) in lieu of quantitative data. If only qualitative data are available for a particular molecule then, instead of the function F, either of the following two expressions may be used to penalize for the difference between the model prediction and the observed qualitative activity:

$$\begin{matrix}{G}_{+} ( z ) = \frac{1}{α} ln ( 1 + {ⅇ}^{α ( z - ɛ )} ) \\ or & ( 15 ) \\ {G}_{-} ( z ) = \frac{1}{α} ln ( 1 + {ⅇ}^{- α ( z + ɛ )} ) & ( 16 )\end{matrix}$$

The choice between the two expressions depends on whether the qualitative data are in the nature of an upper bound on the pKi [equation (16)], or a lower bound on the pKi [equation (15)]. The functions in equations (13) and (14) can then be modified accordingly. FIG. 9B is a plot of G₊ and G₋ from equations (15) and (16), where α=4 and ε=0.5.

It should be noted that the penalty functions provided in equations (12), (15) and (16) are similar in shape to those disclosed in U.S. Pat. Nos. 5,950,146 and 6,269,323. However, the functions in equations (12), (15) and (16) have the distinct advantage of being continuously differentiable and analytic, whereas the functions proposed in U.S. Pat. Nos. 5,950,146 and 6,269,323 are piecewise linear, and therefore not continuously differentiable—much less analytic.

Realigning the Molecules to the Current One-Dimensional QSAR Model

In order to realign a molecule to the current one-dimensional QSAR model, equation (8) must be maximized with respect to the orientation and translation of the molecule's one-dimensional representation. This is relevant both for realigning the training set molecules to the current model, and for making a prediction with the final model for a new molecule. A fixed step size (usually 0.25 bond units) and upper and lower limits,(determined by the bounds of the model and the bounds of the molecule) are chosen. Beginning at the lower limit, the score for the molecule is calculated. The molecule then is moved one step to the right, and the score is calculated again. (This utilizes the bracketing technique disclosed earlier in this specification.) Once a local maximum is bracketed, standard line optimization techniques can be used to find the local maximum to any desired level of accuracy. See, for example, Press, W. H.; Teulkolsky, S. A.; Vetterling, W. T.; Flannery, B. P. Numerical Recipes in C; 2 ed.; Cambridge University Press:.Cambridge, 1997. The global maximum then is the local maximum found with the largest score.

### WORKING EXAMPLE

### Building the One-Dimensional QSAR Model

The one-dimensional QSAR method is demonstrated in the following paragraphs by building a model to predict the binding of molecules to the hERG potassium channel. Due to the cardiotoxicity of molecules that potently inhibit hERG, as discussed above, a model to predict hERG channel activity would be a desirable tool to aid in eliminating this undesirable activity from potential drugs.

First, a data set was assembled from literature sources. This data set consisted of 230 molecules for which an experimentally determined hERG IC50 was available. This data set will be referred to as the “active data set.” The IC50s were measured in a variety of laboratories and under a variety of assay conditions. The inter-laboratory assay variation is typically less than 0.5 log units, as long as the two labs use the same cell line.

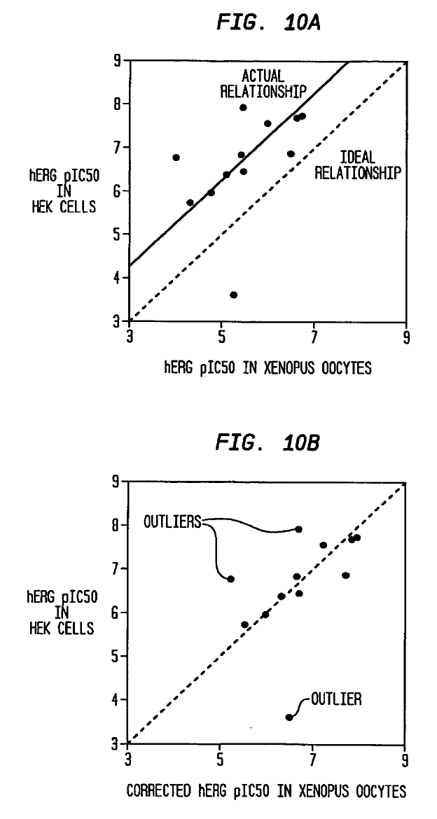

The cell lines in which the hERG IC50 values were measured include human embryo kidney (HEK293) cells, Chinese hamster ovary cells, xenopus oocytes, guinea pig ventricular myocytes and rabbit ventricular myocytes. Not surprisingly, the assay variation can be quite large if the cell lines are different. In some cases, the variation between two assay types is a consistent offset. For example, as depicted in FIG. 10A, the difference between the IC50 of a compound measured in HEK293 cells vs. being measured in Xenopus Oocytes is typically a factor of 10, with the measurement in HEK293 cells being the more potent. This type of consistent variation is easily corrected, as shown in FIG. 10B, by allowing a constant shift depending on the assay type. Thus, in FIG. 10B, for 9 of the 12 plotted compounds, the data agree very well after correction. However, even after correction, there typically are still a few outliers. In the specific case documented in FIG. 10B, one compound is a blatant outlier (˜3 log units different), and two compounds are “borderline” outliers.

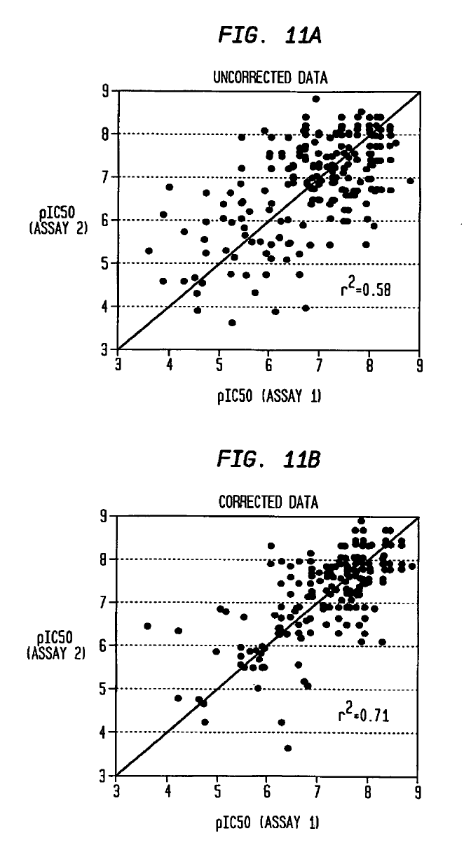

As can be seen in FIG. 11A, prior to correction, the correlation coefficient (r²) between the hERG IC50s of the same compound in different assays is only 0.58. As this is the best that a non-overfit model could achieve on this data set, this would be an unacceptable point to begin building a model. As can be seen in FIG. 11B, after correction, the correlation coefficient increases to 0.71. While this is not an ideal starting point, it is significantly better than the uncorrected data. The number of significant outliers in the corrected data, however, highlights the necessity for using the robust penalty techniques described above.

A data set containing 315 additional molecules with a high probability of being inactive against hERG also was assembled. This data set will be referred to as the “inactive data set.” These molecules include those for which there is experimental evidence that the compounds do not block hERG, as well as commercially available drugs for which there is currently no evidence of cardiotoxicity or hERG inhibition. While it is possible that a handful of these compounds are, in fact, inhibitors of hERG, the vast majority should show little inhibition. The handful of potentially active compounds among the “inactive data set” further highlights the need to use robust penalty techniques.

The 230 molecules in the active data set were split into a training set of 189 molecules and a test set of 41 molecules. Similarly, the 315. molecules in the inactive data set were split into a training set of 256 compounds and a test set of 59 compounds. The training set of compounds from the active data set were regressed against their plC50 values using the function form in equation (13). The training set of compounds from the inactive data set were regressed against the inequality plC50<5 (which corresponds to an IC50>10 uM). For the inactive data set, the function G₊ in equation (15) was used.

The Atom Descriptors

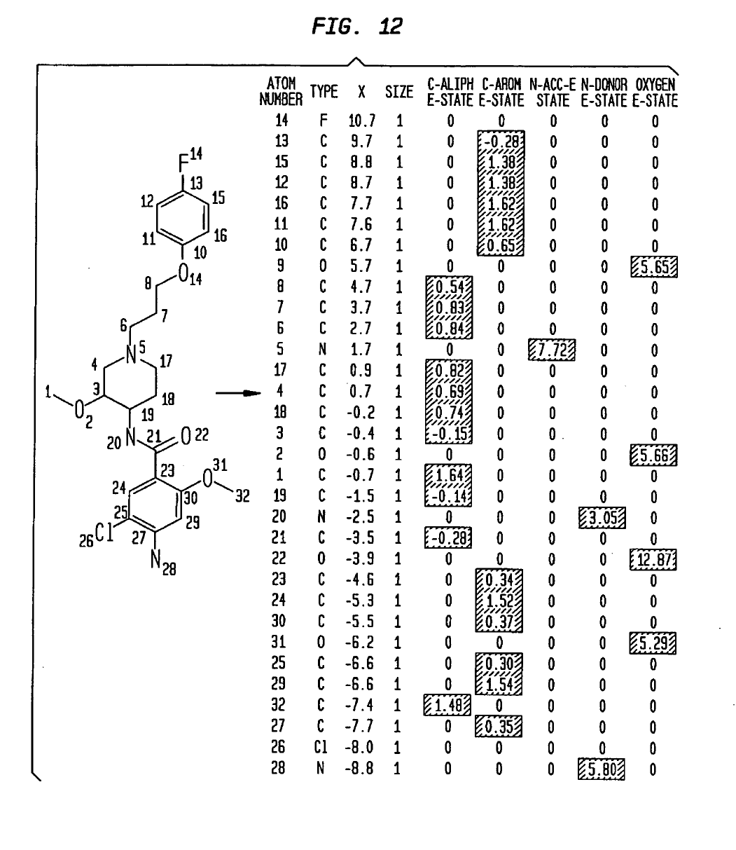

For the purpose of this model, 6 atom descriptors were used: Size, C-Aliph-Estate, C-Arom-Estate, N-Acc-Estate, N-Don-Estate, and O-Estate. FIG. 12 shows the one-dimensional representation and corresponding atom descriptors for the hERG blocker Cisapride.

For the “Size” atom descriptor, every non-hydrogen atom is described with a 1. This might seem to be nothing but a constant term in the regression. However, this is not the case. When the “Size” atom descriptor is converted to the whole molecule descriptor [see equation (6)], it is no longer constant. In fact, the resulting whole molecule descriptor will roughly represent the number of non-hydrogen atoms of the given molecule within the given grid cell.

The “C-Arom Estate” is the electro-topological state of the atom if the atom is a carbon in an aromatic ring; otherwise, it is set to zero. Similarly, the “C-Aliph-Estate” is the Estate of the atom if the atom is a carbon not in an aromatic ring; otherwise, it is set to zero. The reason for differentiating the aliphatic from the aromatic carbons is that aromatic rings are often observed to form critical binding interactions between hERG and its inhibitors.

The “N-Acc-Estate” atom descriptor is 10 minus the Estate of the atom if the atom is a nitrogen with a free lone pair; otherwise, it is set to zero. The reason for specifically singling out the nitrogen acceptor is that a basic center is a common feature in hERG inhibitors. The reason for using 10 minus the Estate value rather than simply the Estate value is that basic nitrogens such as a tertiary amine tend to have lower Estate values than do less basic nitrogens such as the pyridine nitrogen. Thus, using 10 minus the Estate value assigns a higher descriptor to the more basic nitrogens.

The “N-Don-Estate” or “N-Donor-Estate” is the Estate of a nitrogen with an attached hydrogen; otherwise, it is set to zero. The “O-Estate” or “Oxygen-Estate” is the Estate of the atom if the atom is an oxygen; otherwise, it is set to zero. Typically, adding polar groups to an hERG inhibitor diminishes the molecule's affinity for hERG. Thus, these two descriptors are expected to capture this effect.

The Model

The final regression equation used for the hERG model building was

$${Q}_{1} ( {w}_{0} , … , {w}_{NJ} ) = {\sum }_{k = 1}^{K} F ( {a}_{k} - {\sum }_{m = 0}^{NJ} {w}_{m} {D}_{m}^{k} ) + {γ}_{0} {\sum }_{l = 1}^{L} {G}_{+} ( {a}_{+} - {\sum }_{m = 0}^{NJ} {w}_{m} {D}_{m}^{′} ) + {γ}_{1} {\sum }_{j = 1}^{J} ( {w}_{1 j}^{2} + {w}_{Nj}^{2} ) + {γ}_{2} {\sum }_{j = 1}^{J} {\sum }_{n = 1}^{N - 1} {( \frac{{w}_{( n + 1 ) j} - {w}_{nj}}{dx} )}^{2} \qquad ( 17 )$$

where
a) F is defined by equation (12) with α=4.0 and ε=0.5
b) G+ is defined by equation (15) with α=4.0 and ε=0.5
c) γ₀=0.333, γ₁=1000, and γ₂=1000
d) K=the number of compounds in the training set portion of the active data set=189
e) L=the number of compounds in the training set portion of the inactive data set=256
f) N=the number of cells along the one-dimensional axis=60
g) J=the number of atom descriptors used=6
h) a₊=the upper bound for the inactive compounds=plC50=5.0
i) aₖ is the plC50 for molecule k of the “active dataset”
j) dx=the width of the cells along the one-dimensional axis=0.5
   For a given multiple alignment profile, the whole molecule descriptors Dₘ^{k} (=Dₙⱼ^{k} where m=n+(j−1)N) can be calculated for each molecule, and the goal is to determine the corresponding coefficients wₘ for each of the whole molecule descriptors by choosing the wₘ that minimize the function Q. Since the function Q is convex and continuously differentiable in the wₘ, it has a unique minimum, which can be found using any standard gradient-based algorithm; for example, the conjugate gradient minimization algorithm.

In order to obtain an initial alignment of the entire training set, orientation and translation of the one-dimensional representation for each member of the training set were chosen so as to maximize the molecule's alignment with the multiple alignment profile described in the “hERG Validation Study” section. This alignment of the entire training set was then used to build the initial one-dimensional QSAR model via minimizing the function Q in equation (17).

The final one-dimensional QSAR model was the product of 500 iterations of refinement, where a single iteration involved
1. For each compound in the training set, choosing the orientation and translation of its one-dimensional representation that maximizes the predicted activity of the molecule with regard to the one-dimensional QSAR model from the previous iteration. The optimal orientations and translations for the molecules result in a new multiple ligand alignment.
2. Deriving an intermediate one-dimensional QSAR model from the new multiple ligand alignment via minimizing the function Q in equation (17) and
3. Deriving the coefficients wₘ of the one-dimensional QSAR model for this iteration as a weighted average of the coefficients of the intermediate model (wₘⁱ) and the coefficients of the one-dimensional QSAR model from the previous iteration (wₘ^{p}) via wₘ=βwₘⁱ+(1−β)wₘ^{p} where β=0.2.

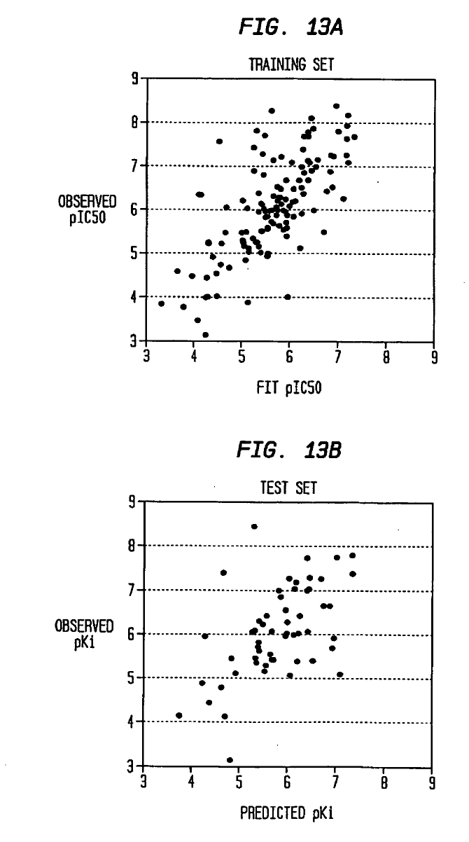

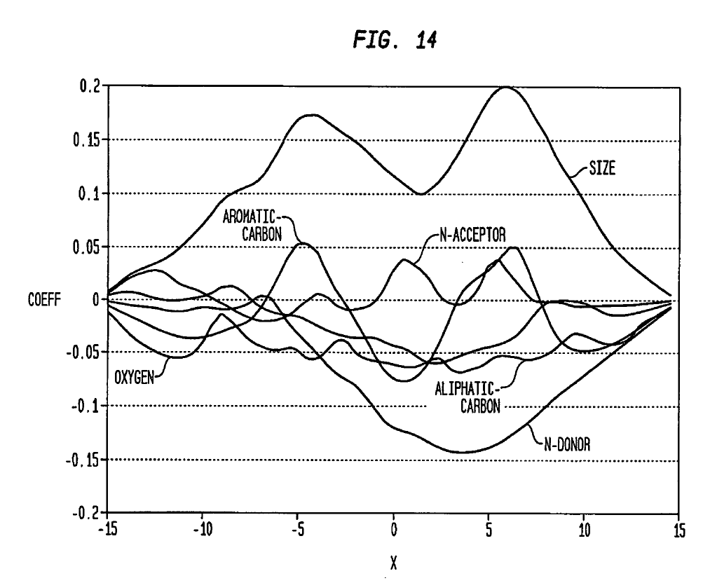

FIG. 13 shows the final fit to the data in the training set and the predictions versus the observed activity for the test set. The model achieves a correlation coefficient (r²) of 0.68 on the training set and a correlation coefficient of 0.76 on the test set. These correlation coefficients are extremely similar to the correlation seen between those for the different assay types (FIG. 11B), and are close to the best correlation possible without overfitting the data.

On the training portion of the inactive data set, the average model plC50 is 4.4 (IC50=40 uM). On the test portion of the inactive data set, the average model pIC50 is 4.5 (IC50=32 uM). Thus, the model building procedure is effectively using both the quantitative information in the active data set as well as the qualitative information available in the inactive data set.

The model coefficients are shown in FIG. 14. Each curve represents the weight for a different atom descriptor. To calculate an atom's contribution to a molecule's predicted hERG affinity, its atom descriptors would be weighted by the value at the particular atom's one-dimensional coordinate. For example, for an aromatic carbon with a one-dimensional coordinate of 5, the weight (˜0.6) would be taken from the curve marked “aromatic-carbon” and multiplied by the particular carbon's Estate value. In addition, the weight (˜0.15) from the size curve is multiplied by the atom's size descriptor (which, in all cases, is 1). Thus, this atom's contribution to the molecule's predicted hERG affinity would be 0.15+0.6*(Atom's Estate).

As can be seen graphically in FIG. 14, the model shows roughly two areas where aromatic rings are preferred. Between these two aromatic rings, there is a peak for a nitrogen acceptor. This acceptor is presumably the basic center that is important in many hERG inhibitors.

The height of the curves in FIG. 14 can be somewhat misleading, as the height of the curve is weighted by the atom descriptor. For size, this value is only 1, but for a nitrogen-acceptor it can be as large as 10.

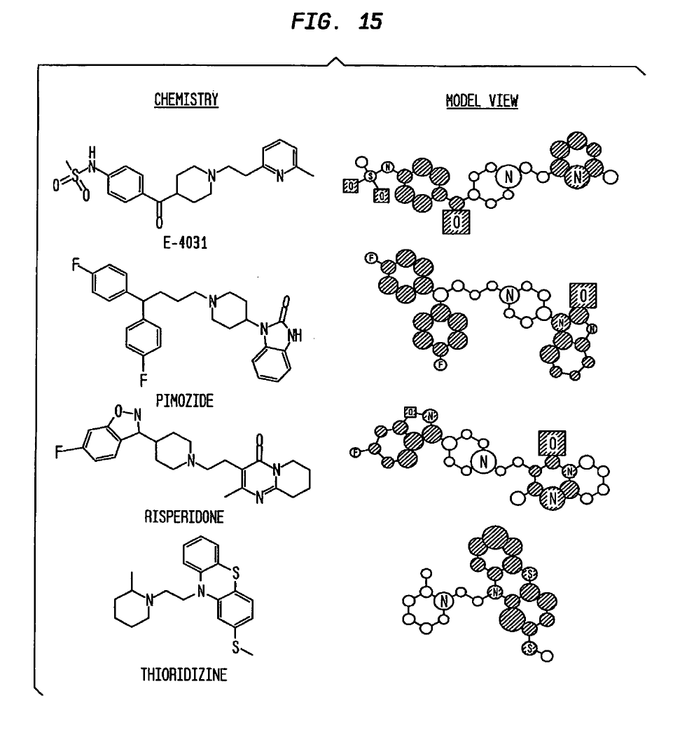

FIG. 15 shows the individual atom contributions to the predicted activity for several classical hERG inhibitors. A circle indicates that the atom is increasing the amount of hERG inhibition, whereas the squares are atoms that are decreasing the hERG inhibition. The size of the circle or square indicates the amount of contribution to the hERG inhibition—either positively or negatively.

One common prominent contributor to many of the known hERG inhibitors is a tertiary amine common to all the compounds shown in FIG. 15, which corresponds to the central peak in the N-acceptor curve in FIG. 14. These nitrogens contribute between 0.4 and 0.5 log units to the predicted hERG plC50s.

The second common prominent contributors to many of the known hERG inhibitors are aromatic rings, which correspond to the two peaks in the aromatic carbon curve in FIG. 14, located on either side of the central amine (see FIG. 15). While individually the atoms of these aromatic rings contribute less than the central amine, collectively each ring contributes between 1.0 and 1.5 log units—more than the central amine itself.

III. Three-Dimensional Multiple Alignment

The goal of this section is to derive alignment constraints from the previously described one-dimensional alignment that can then be used to derive a three-dimensional multiple alignment, thereby trimming the search space considerably and making the three-dimensional alignment problem tractable. The steps followed to convert the one-dimensional multiple alignment profile to a three-dimensional multiple alignment can be summarized as follows:
1. From a set of molecules with a common biological activity of interest, create a one-dimensional multiple alignment profile (hereinafter referred to as the “profile”) of the ligands.
2. Derive intra-molecular constraints based on the topology of each individual molecule. This includes
   a. Any pair of atoms that are bonded are constrained to adopt their ideal bond length, which is generally a function of the bond type and the types of atoms involved.
   b. Any triplet of atoms A, B and C for which A is bonded to B and B is bonded to C are constrained so that the angle formed by ABC is ideal. The ideal bond angle is determined largely by the hybridization of atom B.
   c. Any pair of atoms that are separated by more than 3 bonds are constrained so that their distance is outside their Van der Waals radii. Typically this means the distance is greater than 4.0 Å.
3. Derive inter-molecular constraints from the profile. This involves an analysis of the profile to identify regions of the profile where a statistically significant number of the molecules have similar atoms aligned. These “conserved” positions within the alignment are used to create the inter-molecular constraints.
4. Derive a preliminary three-dimensional alignment by simultaneously satisfying the intra-molecular and inter-molecular constraints.
5. Perform a gradient-based minimization on the preliminary three-dimensional alignment from step 4, based on a scoring function that includes intra-molecular energies and a term to quantify the overall alignment. This largely ensures that the final conformation of each molecule is reasonable without unduly altering the character of the three-dimensional alignment from step 4.
   These steps will be explained in greater detail in the following paragraphs.
   Step 1

First, a one-dimensional multiple alignment profile is created for the ligands of interest. This is done using the methods described earlier in this specification.

Step 2

In order to derive suitable intra-molecular constraints, generic force field parameters derived from the Dreiding force field (see Mayo, S. L., Olafson, B. D., Goddard, W. A., III, “DREIDING: a generic force field for molecular simulations” (1990) Journal of Physical Chemistry 94, 8897-8909, the disclosure of which hereby is incorporated by reference herein in its entirety) were used, although any forcefield parameters could be used. The ideal distances between two bonded atoms are determined from their ideal bond length, which is approximately 1.5 Å for a carbon-carbon bond and varies somewhat for other bonds between other atom types. For 3 atoms A, B, C, in which A is bonded to B and B is bonded to C, the ideal bond angle formed by ABC is determined simply by the hybridization of atom B. For example, if the hybridization of B is Sp1, the angle is 180°; if it is Sp2, the angle is 120°; and if it is Sp3, the angle is 109.5°. The ideal distance between A and C can then be computed based on the ideal bond angle ABC and the ideal bond lengths BC and AB via the formula
d_{AC}²=d_{AB}²+d_{BC}²−2d_{AB}d_{BC} cos(θ)
where d_{AC} is the ideal distance of A to C, d_{AB} is the ideal bond length of A to B, d_{BC} is the ideal bond length of B to C and θ is the ideal bond angle of ABC. Finally, for non-hydrogen atoms in a small molecule that are separated by more than 3 bonds, a simple van der Waals constraint is imposed—that such atoms are to be separated by at least 4.0 Å.
Step 3

Suitable inter-molecular constraints are derived by identifying a handful of positions within the one-dimensional multiple alignment that are relatively conserved; i.e., a statistically significant number of molecules in the alignment have atoms of similar type in roughly the same position of the alignment. These conserved positions within the alignment are then used to derive the inter-molecular constraints. The conserved positions are determined via the combinatorial Principle Component Analysis (cPCA) algorithm (see Anghelescu, A. V., Muchnik, I. B., “Combinatorial PCA and SVM Methods for Feature Selection in Learning Classifications (Applications to Text Categorization)” (2003) Proceedings of the International Conference on Integration of Knowledge Intensive Multi-Agent Systems, 491-496), the disclosure of which hereby is incorporated by reference herein in its entirety).

The cPCA algorithm works as follows. Suppose there are N total atoms in the one-dimensional profile. A symmetric matrix A=∥aᵢⱼ∥ for 1≦i, j≦N is created, where aᵢⱼ=sᵢⱼƒ(xᵢ−xⱼ)
wherein sᵢⱼ is the similarity of atom i to atom j based solely on their atom types, and f is the overlap function that determines and quantifies the degree of overlap of the two atoms based on their respective one-dimensional coordinates, xᵢ and xⱼ, within the one-dimensional profile. The atom similarities sᵢⱼ come either from the BUTTERCUP matrix described previously in this specification or simply by specifying that atoms of identical type have a similarity of 1; otherwise they have a similarity of 0. The function f typically takes one of the two following forms:

$$f ( Δ x ) = \{ \begin{matrix}0 & if \vert Δ x \vert \geq 1 \\ 1 - \vert Δ x \vert & if \vert Δ x \vert < 1\end{matrix} \\ or \\ f ( Δ x ) = {ⅇ}^{- {α ( Δ x - ɛ )}_{+}^{2}}$$

where ε>0 creates a tolerance in the sense that two atoms whose coordinates in the one-dimensional alignment differ by no more than ε still are considered to have an overlap of 1, and where a controls how rapidly the overlap decreases as the one-dimensional separation of the two atoms increases. Suitable values for these constants for use here are α=1.0 and ε=0.1.

Next, the set W={1,2, . . . , N} is defined, which in essence is the union of all atoms in the K molecules being aligned. For any subset of the atoms H⊂W, it is important to define a measure of how similar the atoms in the subset H are to one another. In order to do this, a function, π, is first defined, that measures how similar a single atom is to all the atoms of the subset H. Accordingly,

$$π ( i ; H ) = {\sum }_{j ∈ H} {a}_{ij} ;$$

i.e., the similarity of atom i to the atoms of subset H is merely the sum of the similarities of atom i to the atoms in H (recall that aᵢⱼ as defined above is the similarity of atom i to atom j). Next, a function, F, is defined, that measures how tightly clustered a set H of atoms is. F is defined by the atom of H which is least similar to the other atoms of H. Mathematically, this is given by

$$F ( H ) = {min}_{i ∈ H} \{ π ( i ; H ) \} .$$

Thus, large values of F for a subset H indicate that the atoms in H are very similar to one another. The goal, then, is to find the largest subset of atoms H.⊂W which maximizes the function F(H). This maximal subset will then be the first conserved feature. To find this maximal subset, it is noted that if H.⊂H⊂W and k∈H such that π(k,H)=F(H), then k∉H. (This statement can be proven by contradiction: If k∈H. then

$$F ( {H}_{*} ) = {min}_{i ∈ {H}_{*}} \{ π ( i , {H}_{*} ) \} \leq π ( k ; {H}_{*} ) \leq π ( k ; H ) = F ( H ) .$$

Thus, if k∈H. then H. is not the maximal subset of W.) Armed with this fact, an algorithm now can be constructed which is guaranteed to provide the maximal subset of W.
Algorithm:

1. Construct a sequence of subsets H₀,H₁, . . . , H_{N-1}+532W as follows:
a. H₀=W
b. Then Hₖ is defined by selecting i* ∈Hₖ₊₁ so that π(i*, Hₖ₊₁)=F(Hₖ₊₁) and setting Hₖ=Hₖ₊₁−{i*}.

2. From H₀,H₁, . . . , H_{N-}1, choose the largest value of k so that

$$F ( {H}_{k} ) = {max}_{1 \leq j \leq N} \{ F ( {H}_{j} ) \} .$$

3. Hₖ as defined in step 2 of this algorithm, is the maximal subset of W.

To construct the conserved features, a maximal subset of atoms is selected using the above algorithm. This maximal subset of atoms is the first conserved feature. The atoms in this conserved feature are then removed from the set W, and the procedure is repeated on the remaining set of atoms, resulting in the second conserved feature. This procedure is repeated until the desired number of conserved features are identified. Typically, between 4 and 8 conserved features are derived in this fashion from the one-dimensional multiple alignment.

Step 4

The algorithm used to find a preliminary three-dimensional configuration that satisfies all the intra-molecular and inter-molecular constraints derived in steps 2 and 3 is related to the Stochastic Proximity Embedding algorithm developed by Agrafiotis and coworkers (see Agrafiotis, D. K., Xu, H, “A self-organizing principle for learning nonlinear manifolds” (2002) Proc Natl Acad Sci USA 99, 15869-15872; Agrafiotis, D. K., “Stochastic proximity embedding” (2003) J Comput Chem 24, 1215-1221; Xu, H., Izrailev, S., Agrafiotis, D. K., “Conformational sampling by self-organization” (2003) J Chem Inf Comput Sci 43, 1186-1191, the disclosures of which hereby are incorporated by reference herein in their entireties). Essentially, random coordinates are generated for all the atoms of all the molecules. Next, a random constraint from either step 2 or step 3 is selected. If the atoms relevant to this constraint satisfy the constraint, nothing is done. If the atoms do not satisfy the constraint, they are moved in a manner so as to more closely satisfy the constraint. For example, if atoms A and B are bonded with an ideal bond length of 1.5 Å, but they are found to be separated by 4.3 Å, they are moved towards one another to more fully satisfy the constraint. This process of randomly selecting a constraint and moving the atoms to more fully satisfy the selected constraint is performed in a fixed number of iterations. The constraints and corresponding moves are implemented as described in the following paragraphs.

Both a bond length and a bond angle constraint involve an ideal separation, R₀, between two atoms at positions x₁ and x₂, respectively. If this constraint is selected, the two atoms involved in the constraint are moved in the following way

$${x}_{1}^{new} = {x}_{1}^{old} - 0.5 ρ ( {x}_{2}^{old} - {x}_{1}^{old} ) ( \frac{{R}_{0}}{{d}_{12}^{old}} - 1 )$$

$${x}_{2}^{new} = {x}_{2}^{old} + 0.5 ρ ( {x}_{2}^{old} - {x}_{1}^{old} ) ( \frac{{R}_{0}}{{d}_{12}^{old}} - 1 )$$

where ρ is a positive number that controls the extent to which the constraint is satisfied upon selection, and d₁₂ is the distance between atoms 1 and 2. After moving the two atoms according to this formula, the new distance is
d₁₂^{new}=d₁₂^{old}(1−ρ)+R₀ρ,
which shows that for 0<ρ<1 the atoms move so as to be closer to their ideal distance. In practice, ρ is varied during the optimization—usually starting at a high value and slowly decreasing.

For a van der Waals constraint, the only concern is that the relevant pair of atoms not be closer to one another than a certain predetermined distance (R₀). In this case, if the two atoms have a distance greater than R₀, they are not moved, but if the distance is less than R₀, they are moved according to the above formula given for a bond angle/bond distance constraint.

The above-described intra-molecular constraints, of course, always involve two atoms from the same molecule. The inter-molecular constraints derived from the one-dimensional profile are more complex in that these involve a varying number (including 0 and above) of atoms from each molecule. Essentially, when this constraint is selected, the center of mass of all the atoms involved in the constraint is calculated. Those atoms involved in the constraint, for each individual molecule, are collectively moved so that their center of mass is closer to the center of mass of the entire collection. To describe this mathematically, the following notation is used:

N=the number of molecules

Mᵢ=the number of atoms from molecule i involved in the constraint

$$\begin{matrix}K = {\sum }_{i = 1}^{N} {M}_{i} \\ = the total number of atoms involved in the constraint\end{matrix}$$

xᵢⱼ=the position of the jth atom involved in the constraint from the ith molecule

$$C = \frac{1}{ K} {\sum }_{i = 1}^{ N} {\sum }_{j = 1}^{ {M}_{ i}} {x}_{ ij} = the center of mass of all atoms involved in the constraint$$

$${C}_{ i} = \frac{1}{ M} {\sum }_{j = 1}^{ {M}_{ i}} {x}_{ ij} = the center of mass of those atoms involved in the constraint from molecule i .$$

The goal when moving the atoms according to this constraint is to make the individual Cᵢ closer to C. This is accomplished by moving each atom in the constraint via the formula
xᵢⱼ^{new}=xᵢⱼ^{old}−ρ(C_{i.}−C).
Step 5

The gradient minimization is performed using the conjugate gradient algorithm. The score used to optimize is a combination of (i) the usual forcefield terms (such as ideal bond length terms, ideal bond angle terms, dihedral angle terms and van der Waals terms) to ensure that each conformation arrived at in step 4 is reasonable, and (ii) an alignment scoring function to ensure that the overall alignment arrived at in step 4 remains reasonable. The alignment scoring function is essentially that developed by Labute and co-workers (Labute, P., Williams, C., Feher, M., Sourial, E., Schmidt, J. M., “Flexible alignment of small molecules” (2001) J Med Chem 44, 1483-1490, the disclosure of which hereby is incorporated by reference herein in its entirety). The alignment score has the generic form:

$$Alignment Score = {\sum }_{i < j} {\sum }_{k = 1}^{{N}_{i}} {\sum }_{m = 1}^{{N}_{j}} S ( {α}_{ik} , {α}_{jm} ) f ( \vert {x}_{ik} - {x}_{jm} \vert )$$

where the outer sum is over all pairs of molecules i,j where i≠4; the middle sum is over all atoms of molecule i; the inner sum is over all atoms of molecule j; S is a function that determines the similarity of two atoms; and f is a distance-dependent overlap function that measures the degree of overlap of the two atoms depending only on their spatial location. To define the similarity function, each atom is assigned a certain number of properties:

1. Volume—Any non-hydrogen atom

2. Aromatic—Any atom in an aromatic ring

3. Donor—Any nitrogen, oxygen, or sulfur with a hydrogen

4. Acceptor—Any nitrogen or oxygen atom having a lone electron pair capable of accepting a hydrogen bond

5. Hydrophobe—Any carbon not bonded to a heteroatom.

Alternatively, other atom features could be used, such as whether the atom is protonated or deprotonated at physiological pH, atomic point charges, pKa, atomic surface areas, etc.

So an atom A is described by
A=(c₁^{A},c₂^{A},c₃^{A},c₄^{A},c₅^{A})
where each cᵢ is either 1 or 0, indicating whether or not atom A has property i in the list above. Then the similarity between two atoms A and B is

$$S ( A , B ) = {\sum }_{i = 1}^{5} {w}_{i} {c}_{i}^{A} {c}_{i}^{B}$$

where the wᵢ are weighting factors to balance the importance of each possible property. Typical values for the wᵢ are: w₁=3, w₂=3, w₃=10, w₄=10, w₅=1. Finally, if R is the distance between the two atoms of interest, then the atomic overlap function f is defined as
f(R)=(2πσ)^{-3/2}e^{-R}^{²}^{/2σ}^{²}
where σ is a positive number that controls the extent of overlap of two atoms that are relatively far apart. The expectation is that two large atoms will show more overlap at large distances than would two small atoms. Thus σ typically is taken to be proportional to the van der Waals radii of the two atoms involved via the formula:

$${σ}^{2} = \frac{{r}_{1}^{2} + {r}_{2}^{2}}{6.25} .$$

### WORKING EXAMPLE

### Three-Dimensional Multiple Alignment

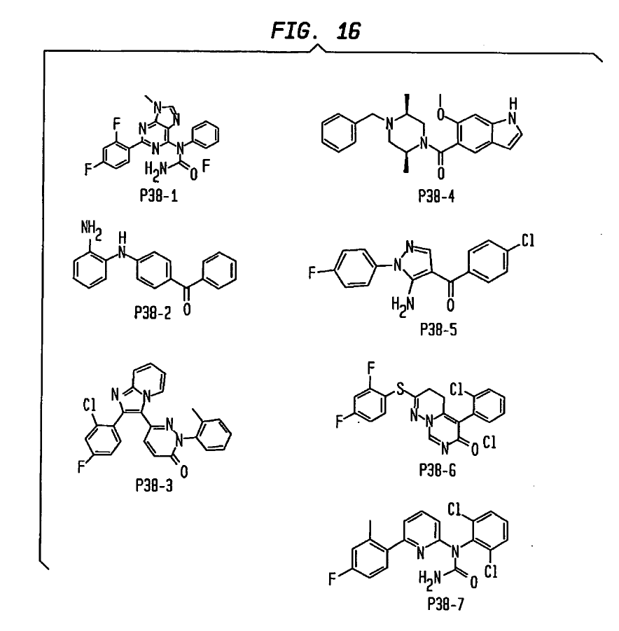

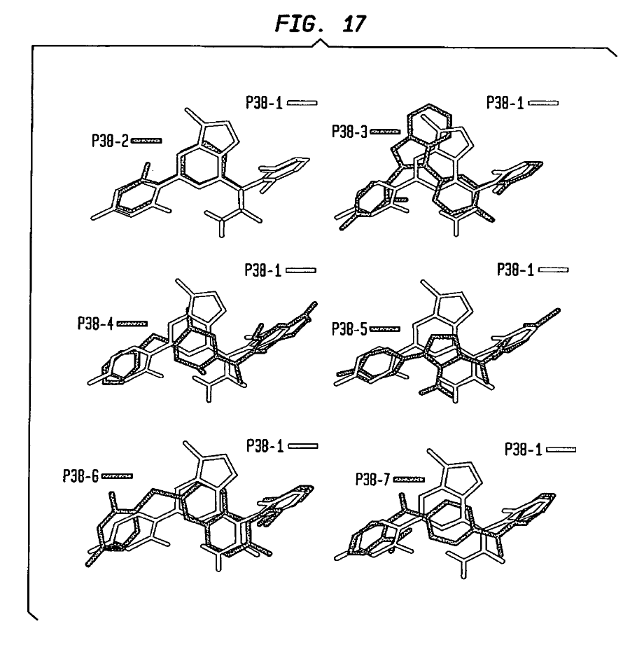

For the purposes of this example, a set of seven different inhibitors of p38 kinase was used, as shown in FIG. 16. The above steps 1 through 5 were applied to this set of molecules p38-1 through p38-7, to generate a three-dimensional multiple alignment. FIG. 17 depicts certain results of this alignment. For clarity of presentation, each molecule (p38-2 -p38-7) is shown in a separate picture aligned to p38-1. In each image, p38-1 is shown in light gray, and the other molecule is shown in dark gray. The frame of reference for the molecule p38-1 is exactly the same in all six pictures. This alignment effectively captures a key pharmacophore: aromatic ring in the bottom left of each picture, the carbonyl oxygen in the lower right, and the aromatic ring in the middle right. This binding pharmacophore is now well understood from p38 co-crystal structures.

The foregoing description details certain embodiments of the invention. It will be appreciated, however, that the invention can be practiced in many ways. It also should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of constructing a one-dimensional QSAR model for small molecule drug candidates, comprising the steps of:
(a) selecting a set of K reference molecules known either to possess or not possess a biological activity of interest, wherein at least one of the K reference molecules possesses the biological activity of interest;
(b) deriving a set of K one-dimensional molecular representations, wherein each of said representations in the set is derived from a different one of the K molecules in said reference set;
(c) aligning all K of the one-dimensional representations in said set along a one-dimensional axis, in order to obtain a multiple alignment profile of the K reference molecules; and
(d) deriving a computational model of the biological activity of interest using the multiple alignment profile.

2. The method of claim 1, wherein said aligning comprises the steps of:
(c1) using a scoring function to rank any multiple alignment of the one-dimensional representations of the K reference molecules; and
(c2) using a global optimization algorithm to search through the potential orientations and translations of the one-dimensional representations of the K reference molecules to find the optimal scoring multiple alignment or near-optimal scoring multiple alignments of the one-dimensional representations of the K reference molecules.

3. The method of claim 2 wherein said scoring function comprises:
(i) assigning an atom type to each atom in each of the K reference molecules;
(ii) defining a similarity matrix which contains the similarity of any possible pair of atom types from different molecules; and
(iii) scoring a multiple alignment as the sum, over all pairs of atoms from different molecules, of the similarity of the two atoms times their area of overlap in the multiple alignment.

4. The method of claim 2, wherein said global optimization algorithm is a combination of (i) a genetic algorithm to optimize the orientations and (ii) evolutionary programming to simultaneously optimize the translations of the one-dimensional representations of the K reference molecules.

5. The method of claim 4, wherein said aligning comprises the steps of:
(1) selecting a first generation of potential solutions, wherein each potential solution consists of an orientation and translation for each of the K one-dimensional representations;
(2) using the scoring function to assess the fitness of each of the potential solutions in said first generation;
(3) selecting a new generation of potential solutions, wherein each potential solution in said new generation
(i) consists of an orientation and translation for each of the K one-dimensional representations, and
(ii) is based on the fitness, assessed via the scoring function, of one or more solutions in the preceding generation and/or a random recombination of the orientations and translations, respectively, of two distinct solutions in the preceding generation;
(4) using the scoring function to assess the fitness of each of the potential solutions in said new generation; and
(5) repeating steps (3) and (4) until an optimal or near optimal multiple alignment profile is achieved.

6. The method of claim 5, wherein the translations of said first generation of potential solutions are distributed according to a Gaussian distribution.

7. The method of claim 5, wherein the selecting in step (3) is performed via roulette wheel selection.

8. The method of claim 5, wherein step (3) further comprises modifying one or more members of the new generation of potential solutions by
(i) reversing one or more of the orientations of a potential solution, or
(ii) using a Gaussian distribution to alter the translations of a potential solution.

9. The method of claim 1, further comprising the steps of:
(e) deriving a one-dimensional representation of a candidate molecule;
(f) aligning the one-dimensional representation of the candidate molecule with the multiple alignment profile of the K reference molecules; and
(g) determining the likelihood that the candidate molecule will have the biological activity of interest, based on the degree of alignment found in step (f).

10. The method of claim 2, wherein said deriving the computational model comprises the steps of:
(d1) assigning a set of physicochemical descriptors to each atom in each of the K reference molecules;
(d2) correlating the atom descriptors assigned in step (d1) and the coordinates of the respective atoms within the current multiple alignment profile to the corresponding molecule's level of biological activity to create an iteration of a one-dimensional QSAR model;
(d3) deriving a new multiple alignment profile of the K reference molecules by realigning these to the current iteration of the one-dimensional QSAR model; and
(d4) iterating steps (d2) and (d3) until a final version of the one-dimensional QSAR model is obtained.

11. The method of claim 10, wherein the descriptors are selected from the group consisting of size, atom type, partial charge, electro-topological state, surface area, pKa, and hydrogen bonding capacity.

12. The method of claim 10 wherein the current multiple alignment profile is derived by:
(a) creating an initial multiple alignment profile of a subset of the K reference compounds known to possess the biological activity of interest; and
(b) aligning the remainder of the K reference compounds to the initial multiple alignment profile.

13. The method of claim 10, wherein correlating the atom descriptors and the respective coordinates within the multiple alignment profile to the corresponding molecule's level of biological activity comprises:
(A) for each atom descriptor, partitioning the one-dimensional axis into a finite number of cells; and
(B) selecting a constant term and a coefficient for each atom descriptor in each cell along the one-dimensional axis by simultaneously minimizing:
(i) the difference between the predicted activity and the observed activity of each reference molecule for which a quantitative level of biological activity is known;
(ii) the extent to which the predicted activity is above some predetermined level for each of the reference molecules known only to be inactive; and
(iii) the difference between the coefficients corresponding to the same atom descriptor in neighboring cells.

14. The method of claim 13, wherein said correlating is performed by robust linear regression.

15. The method of claim 10, wherein said deriving a new multiple alignment profile comprises:
(i) choosing the orientation and translation for the one-dimensional representation of each reference molecule, so as to maximize the reference molecule's predicted biological activity level according to the current iteration of the one-dimensional QSAR model; and
(ii) using the orientations and translations chosen in step (i) to form a new multiple alignment profile of the K reference molecules.

16. The method of claim 10, wherein said iterating further comprises:
(i) creating an intermediate one-dimensional QSAR model from the current multiple alignment profile of the reference compounds; and
(ii) creating the next iteration of the one-dimensional QSAR model as a weighted average of the one-dimensional QSAR model from the current iteration and the intermediate one-dimensional QSAR model.

17. A system for constructing a one-dimensional QSAR model for small molecule drug candidates, comprising:
(a) means for selecting a set of K reference molecules known either to possess or not possess a biological activity of interest, wherein at least one of the K reference molecules possesses the biological activity of interest;
(b) means for deriving a set of K one-dimensional molecular representations, wherein each of said representations in the set is derived from a different one of the K molecules in said reference set;
(c) means for aligning all K of the one-dimensional representations in said set along a one-dimensional axis, in order to obtain a multiple alignment profile of the K reference molecules; and
(d) means for deriving a computational model of the biological activity of interest using the multiple alignment profile.

18. The system of claim 17, wherein said means for aligning comprises:
(c1) means for using a scoring function to rank any multiple alignment of the one-dimensional representations of the K reference molecules; and
(c2) means for using a global optimization algorithm to search through the potential orientations and translations of the one-dimensional representations of the K reference molecules to find the optimal scoring multiple alignment or near-optimal scoring multiple alignments of the one-dimensional representations of the K reference molecules.

19. The system of claim 18 wherein said scoring function comprises:
(i) assigning an atom type to each atom in each of the K reference molecules;
(ii) defining a similarity matrix which contains the similarity of any possible pair of atom types from different molecules; and
(iii) scoring a multiple alignment as the sum, over all pairs of atoms from different molecules, of the similarity of the two atoms times their area of overlap in the multiple alignment.

20. The system of claim 18, wherein said global optimization algorithm is a combination of (i) a genetic algorithm to optimize the orientations and (ii) evolutionary programming to simultaneously optimize the translations of the one-dimensional representations of the K reference molecules.

21. The system of claim 20, wherein said aligning comprises the steps of:
(1) selecting a first generation of potential solutions, wherein each potential solution consists of an orientation and translation for each of the K one-dimensional representations;
(2) using the scoring function to assess the fitness of each of the potential solutions in said first generation;
(3) selecting a new generation of potential solutions, wherein each potential solution in said new generation
(i) consists of an orientation and translation for each of the K one-dimensional representations, and
(ii) is based on the fitness, assessed via the scoring function, of one or more solutions in the preceding generation and/or a random recombination of the orientations and translations, respectively, of two distinct solutions in the preceding generation;
(4) using the scoring function to assess the fitness of each of the potential solutions in said new generation; and
(5) repeating steps (3) and (4) until an optimal or near optimal multiple alignment profile is achieved.

22. The system of claim 21, wherein the translations of said first generation of potential solutions are distributed according to a Gaussian distribution.

23. The system of claim 21, wherein the selecting in step (3) is performed via roulette wheel selection.

24. The system of claim 21, wherein step (3) further comprises modifying one or more members of the new generation of potential solutions by
(i) reversing one or more of the orientations of a potential solution, or
(ii) using a Gaussian distribution to alter the translations of a potential solution.

25. The system of claim 17, further comprising:
(e) means for deriving a one-dimensional representation of a candidate molecule;
(f) means for aligning the one-dimensional representation of the candidate molecule with the multiple alignment profile of the K reference molecules; and
(g) means for determining the likelihood that the candidate molecule will have the biological activity of interest, based on the degree of alignment found in (f).

26. The system of claim 18, wherein said deriving the computational model comprises the steps of:
(d1) assigning a set of physicochemical descriptors to each atom in each of the K reference molecules;
(d2) correlating the atom descriptors assigned in step (d1) and the coordinates of the respective atoms within the current multiple alignment profile to the corresponding molecule's level of biological activity to create an iteration of a one-dimensional QSAR model;
(d3) deriving a new multiple alignment profile of the K reference molecules by realigning these to the current iteration of the one-dimensional QSAR model; and
(d4) iterating steps (d2) and (d3) until a final version of the one-dimensional QSAR model is obtained.

27. The system of claim 26, wherein the descriptors are selected from the group consisting of size, atom type, partial charge, electro-topological state, surface area, pKa, and hydrogen bonding capacity.

28. The system of claim 26 wherein the current multiple alignment profile is derived by:
(a) creating an initial multiple alignment profile of a subset of the K reference compounds known to possess the biological activity of interest; and
(b) aligning the remainder of the K reference compounds to the initial multiple alignment profile.

29. The system of claim 26, wherein correlating the atom descriptors and the respective coordinates within the multiple alignment profile to the corresponding molecule's level of biological activity comprises:
(A) for each atom descriptor, partitioning the one-dimensional axis into a finite number of cells; and
(B) selecting a constant term and a coefficient for each atom descriptor in each cell along the one-dimensional axis by simultaneously minimizing:
(i) the difference between the predicted activity and the observed activity of each reference molecule for which a quantitative level of biological activity is known;
(ii) the extent to which the predicted activity is above some predetermined level for each of the reference molecules known only to be inactive; and
(iii) the difference between the coefficients corresponding to the same atom descriptor in neighboring cells.

30. The system of claim 29, wherein said correlating is performed by robust linear regression.

31. The system of claim 26, wherein said deriving a new multiple alignment profile comprises:
(i) choosing the orientation and translation for the one-dimensional representation of each reference molecule, so as to maximize the reference molecule's predicted biological activity level according to the current iteration of the one-dimensional QSAR model; and
(ii) using the orientations and translations chosen in step (i) to form a new multiple alignment profile of the K reference molecules.

32. The system of claim 26, wherein said iterating further comprises:
(i) creating an intermediate one-dimensional QSAR model from the current multiple alignment profile of the reference compounds; and
(ii) creating the next iteration of the one-dimensional QSAR model as a weighted average of the one-dimensional QSAR model from the current iteration and the intermediate one-dimensional QSAR model.

33. A high-speed method of creating a three-dimensional multiple alignment of a set of molecules, comprising the steps of:
(a) selecting a set of K reference molecules known to possess a biological activity of interest;
(b) deriving a set of K one-dimensional molecular representations, wherein each of said representations in the set is derived from a different one of the K molecules in said reference set;
(c) aligning all K of the one-dimensional representations in said set along a one-dimensional axis, in order to obtain a one-dimensional multiple alignment profile of the K reference molecules;
(d) deriving intra-molecular constraints for a three-dimensional multiple alignment, based on the topology of each of the K reference molecules;
(e) deriving inter-molecular constraints for a three-dimensional multiple alignment, based on the one-dimensional multiple alignment profile obtained in step (c);
(f) deriving a preliminary three-dimensional multiple alignment profile of the K reference compounds based on the intra-molecular and inter-molecular constraints derived in steps (d) and (e), respectively; and
(g) performing a gradient-based minimization on the preliminary three-dimensional multiple alignment profile derived in step (f).

34. The method of claim 33, wherein said deriving intra-molecular constraints comprises using force field parameters to determine ideal bond lengths, ideal bond angles, and van der Waals radii for said representative three-dimensional structure.

35. The method of claim 33, wherein said deriving inter-molecular constraints comprises applying the combinatorial Principle Component Analysis algorithm to identify regions of the one-dimensional multiple alignment profile where a statistically significant number of the molecules have similar atoms aligned.

36. The method of claim 33, wherein said deriving a preliminary three-dimensional multiple alignment profile of the K reference compounds comprises applying the Stochastic Proximity Embedding algorithm to simultaneously satisfy the intra-molecular and inter-molecular constraints derived in steps (d) and (e), respectively.

37. The method of claim 33, wherein said gradient-based minimization is based on a scoring function that includes intra-molecular energies and a term to quantify the overall alignment of the molecules.

38. The method of claim 37, wherein said gradient-based minimization is performed using the conjugate gradient algorithm.

39. A system for creating a high-speed, three-dimensional multiple alignment of a set of molecules, comprising:
(a) means for selecting a set of K reference molecules known to possess a biological activity of interest;
(b) means for deriving a set of K one-dimensional molecular representations, wherein each of said representations in the set is derived from a different one of the K molecules in said reference set;
(c) means for aligning all K of the one-dimensional representations in said set along a one-dimensional axis, in order to obtain a one-dimensional multiple alignment profile of the K reference molecules;
(d) means for deriving intra-molecular constraints for a three-dimensional multiple alignment, based on the topology of each of the K reference molecules;
(e) means for deriving inter-molecular constraints for a three-dimensional multiple alignment, based on said one-dimensional multiple alignment profile;
(f) means for deriving a preliminary three-dimensional multiple alignment profile of the K reference compounds based on said intra-molecular and inter-molecular constraints; and
(g) means for performing a gradient-based minimization on said preliminary three-dimensional multiple alignment profile.

40. The system of claim 39, wherein said deriving intra-molecular constraints comprises using force field parameters to determine ideal bond lengths, ideal bond angles, and van der Waals radii for said representative three-dimensional structure.

41. The system of claim 39, wherein said deriving inter-molecular constraints comprises applying the combinatorial Principle Component Analysis algorithm to identify regions of the one-dimensional multiple alignment profile where a statistically significant number of the molecules have similar atoms aligned.

42. The system of claim 39, wherein said deriving a preliminary three-dimensional multiple alignment profile of the K reference compounds comprises applying the Stochastic Proximity Embedding algorithm to simultaneously satisfy said intra-molecular and inter-molecular constraints.

43. The system of claim 39, wherein said gradient-based minimization is based on a scoring function that includes intra-molecular energies and a term to quantify the overall alignment of the molecules.

44. The system of claim 43, wherein said gradient-based minimization is performed using the conjugate gradient algorithm.
